(19) United States
(12) Patent Application Publication
(10) Pub. No.: US 2019/0325777 A1
(43) Pub. Date: Oct. 24, 2019

(54) CONSEQUENCE RECORDING AND PLAYBACK IN DIGITAL PROGRAMS

(71) Applicant: KONINKLIJKE PHILIPS N.V., Eindhoven (NL)

(72) Inventors: ANNERIEKE HEUVELINK-MARCK, EINDHOVEN (NL); COLIN BOS, EINDHOVEN (NL); JAN VAN SWEEVELT, EINDHOVEN (NL)

(21) Appl. No.: 15/958,272

(22) Filed: Apr. 20, 2018

(51) Int. Cl. G09B 19/00

(52) U.S. Cl. CPC G09B 19/00

(57) ABSTRACT

In an embodiment, a method implemented by one or more processors, comprising: receiving one or more recordings of one or more consequences of one or more of activity or inactivity of a user related to a predetermined goal; determining that an opportunity for the user to engage in, or refrain from, a subsequent activity that will affect progression of the predetermined goal is present; and triggering a playback of the one or more recordings to the user based on the determined opportunity.

### FIELD OF THE INVENTION

The present invention is generally related to behavioral activity monitoring and, more particularly, electronic support to motivate changes in behavior.

### BACKGROUND OF THE INVENTION

Digital behavioral change (BC) programs are increasingly used in the consumer and clinical domain to stimulate healthy lifestyles (e.g., physical activity, healthy diet, etc.) and/or self-management behaviors. These BC programs often provide information about health, work with a set of goals, and include monitoring of behaviors and feeding back progress (e.g., show number of steps).

People's intentions to change behavior to become healthier may be quite strong, but good intentions are often not translated into actual behavior, particularly in the context of health behaviors. One important reason that behavior change fails is because the positive effects of the new behavior (e.g., losing weight through exercising, lowering the chance to get lung disease by quitting smoking, etc.) are often psychologically distant, while the (perceived) negative effects of that new behavior are much closer (e.g., having to get up from the couch, not having the perceived pleasure of a smoke, etc.). The larger the psychological distance towards the positive effects of the new behavior, the more likely behavior change is going to fail.

### SUMMARY OF THE INVENTION

In one embodiment, a method implemented by one or more processors, comprising: receiving one or more recordings of one or more consequences of one or more of activity or inactivity of a user related to a predetermined goal; determining that an opportunity for the user to engage in, or refrain from, a subsequent activity that will affect progression of the predetermined goal is present; and triggering a playback of the one or more recordings to the user based on the determined opportunity.

These and other aspects of the invention will be apparent from and elucidated with reference to the embodiment(s) described hereinafter.

### BRIEF DESCRIPTION OF THE DRAWINGS

Many aspects of the invention can be better understood with reference to the following drawings, which are diagrammatic. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram that illustrates an example environment in which a consequence recording and playback system is used, in accordance with an embodiment of the invention.

FIG. 2 is a schematic diagram that illustrates an example wearable device in which all or a portion of the functionality of a consequence recording and playback system may be implemented, in accordance with an embodiment of the invention.

FIG. 3 is a schematic diagram that illustrates an example electronics device in which all or a portion of the functionality of a consequence recording and playback system may be implemented, in accordance with an embodiment of the invention.

FIG. 4 is a schematic diagram that illustrates an example computing device in which all or a portion of the functionality of a consequence recording and playback system may be implemented, in accordance with an embodiment of the invention.

FIG. 5 is a flow diagram that conceptually illustrates an embodiment of a consequence recording and playback process using manual control, in accordance with an embodiment of the invention.

FIG. 6 is a flow diagram that conceptually illustrates an embodiment of a consequence recording and playback process using automatic control, in accordance with an embodiment of the invention.

FIG. 7 is a flow diagram that illustrates an example consequence recording and playback method, in accordance with an embodiment of the invention.

### DETAILED DESCRIPTION OF EMBODIMENTS

Disclosed herein are certain embodiments of a consequence recording and playback system, apparatus, method, and computer readable medium (herein, also collectively referred to as a consequence recording and playback system) that tracks a user's behavioral activity (and/or inactivity) with respect to a specific, predefined behavior change goal, tracks the effects of those behaviors, and provides support to the user in real-time, in-situ, at moments where decisions are made that have a clear relation with the behavior change goal by showing the expected effects of the various choice options. The system is based, at least in part, on a premise that the user wants to change a certain behavior. In one embodiment, a consequence recording and playback system relies on manual input of the executed behavior and the experienced health, emotional, social or environmental consequences, as well as the manual request for support. For instance, in the context of a user wanting to exercise more, after exercising, the user inputs his/her (hereinafter, using the male gender for convenience) experiences actively (e.g., in writing, voice input, record a video, a still image, etc.). The user is then able to retrieve these inputs on a moment he needs support (e.g., when one does not feel like exercising). In a more advanced embodiment, a consequence recording and playback system provides automatic tracking of behavior, logging (with or without prodding of the user and/or others) of its consequences, and pro-actively relaying of information on expected effects under current circumstances (context) based on previously logged, self-reported effects. For instance, in the context of wanting to exercise more, a smart chair may register a time the user is sedentary (tracking), camera functionality of an apparatus (e.g., a mobile phone camera) may record feelings of the user when he exercises or does not exercise (logging consequences), and when the recording is triggered for playback, providing a message containing text, audio, and/or video about the consequences of (and/or of not) exercising (relaying of information).

Digressing briefly, current digital behavioral change (BC) programs may track a user's activities (e.g., behavior) and collect the corresponding data and possibly contextual information, analyzing the consequences of the behavior and presenting motivational messages to the user. However, current BC programs neither record the consequences nor use the recordings as motivation. In other words, the potential for narrowing the intention-behavior gap, perhaps significantly, exists for conventional systems. Certain embodiments of a consequence recording and playback system record the consequences and use the recorded consequences to promote behavioral change at opportune times. By doing so, certain embodiments of a consequence recording and playback system may decrease the psychological distance of consequences by making them more salient through using personal (previous) experiences (or experiences of others) of these consequences (e.g., a video about being happy when having exercised, a video about feeling really wheezy after smoking a lot, video of an unhappy family member when the user behaves in a particular way, etc.).

Having summarized certain features of a consequence recording and playback system of the present disclosure, reference will now be made in detail to the description of a consequence recording and playback system as illustrated in the drawings. While a consequence recording and playback system will be described in connection with these drawings, there is no intent to limit the consequence recording and playback system to the embodiment or embodiments disclosed herein. For instance, though described in the context of health management services, certain embodiments of a consequence recording and playback system may be used to influence the behavior of a user in other contexts, including the areas of care plan adherence, medical equipment usage compliance, countering addictions or other harmful behavior, finance or other business or personnel management. Further, although the description identifies or describes specifics of one or more embodiments, such specifics are not necessarily part of every embodiment, nor are all various stated advantages necessarily associated with a single embodiment or all embodiments. On the contrary, the intent is to cover all alternatives, modifications and equivalents consistent with the disclosure as defined by the appended claims. Further, it should be appreciated in the context of the present disclosure that the claims are not necessarily limited to the particular embodiments set out in the description.

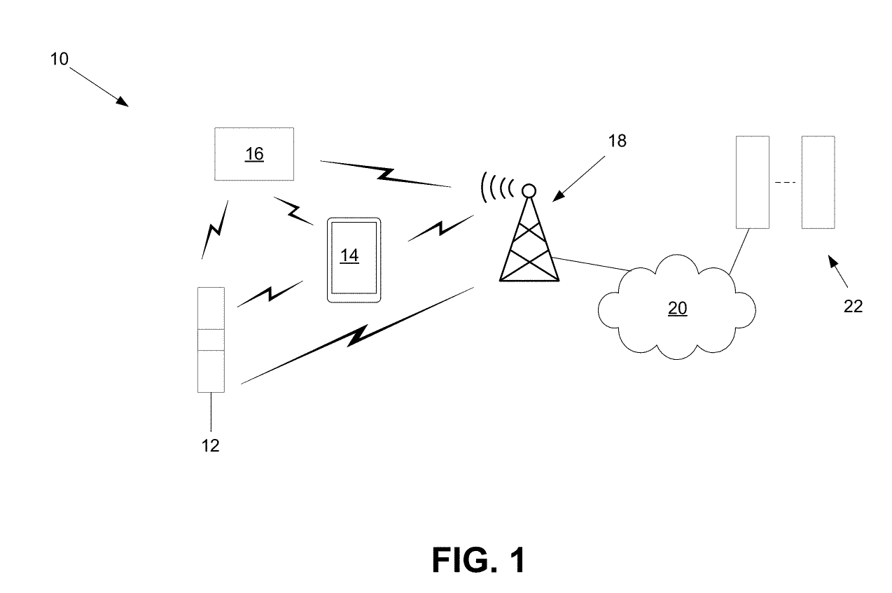

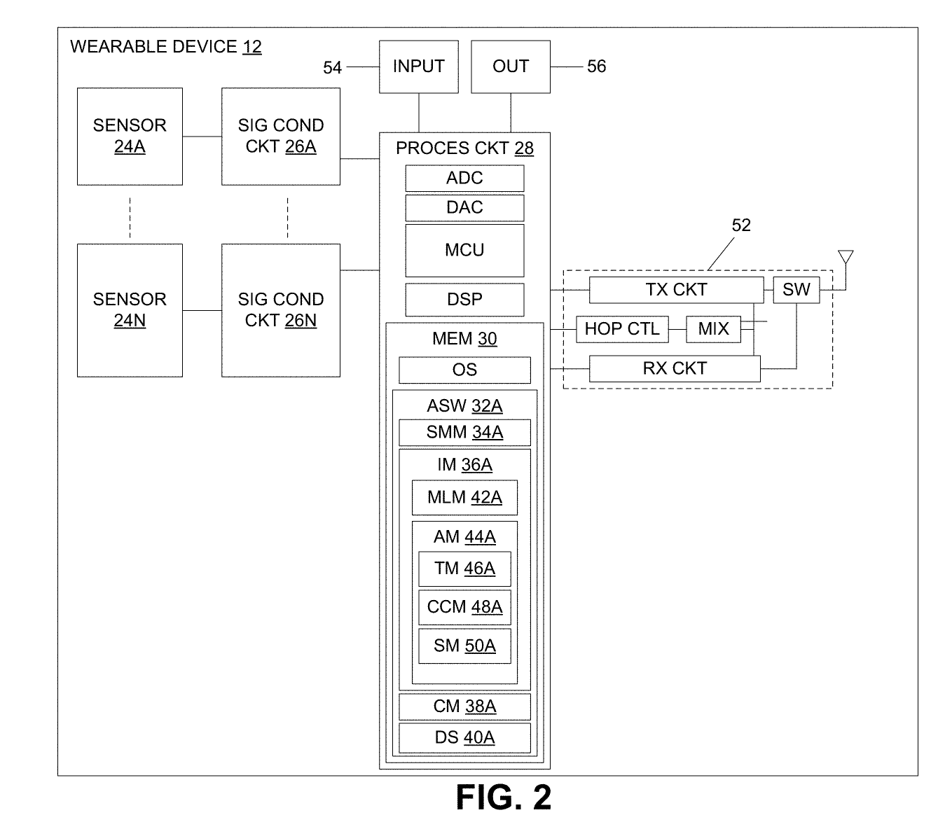

Referring now to FIG. 1, shown is an example environment 10 in which certain embodiments of a consequence recording and playback system may be implemented. It should be appreciated by one having ordinary skill in the art in the context of the present disclosure that the environment 10 is one example among many, and that some embodiments of a consequence recording and playback system may be used in environments with fewer, greater, and/or different components that those depicted in FIG. 1. The environment 10 comprises a plurality of devices that enable communication of information throughout one or more networks. The depicted environment 10 comprises a wearable device 12, an electronics (e.g., portable) device 14, one or more monitoring devices 16, a wireless/cellular network 18, a wide area network 20 (e.g., also described herein as the Internet), and a remote computing system 22. The wearable device 12, as described further in association with FIG. 2, and in one embodiment, is configured to perform all or at least a portion of the functionality of a consequence recording and playback system. The wearable device 12 is typically worn by the user (e.g., around the wrist or torso, as a patch, or attached to an article of clothing), and comprises a plurality of sensors that track physical activity (and/or inactivity) of the user (e.g., steps, swim strokes, pedaling strokes, sports activities, sleeping behavior, breathing behavior, etc.), and is configured to sense/measure or derive physiological parameters (e.g., heart rate, respiration, skin temperature, etc.) based on the sensor data, and optionally sense various other parameters (e.g., circumstances or context, including outdoor temperature, humidity, location, etc.) pertaining to the surrounding environment of the wearable device 12. Note that the terms circumstances and context are used herein interchangeably. For instance, in some embodiments, the wearable device 12 may comprise a global navigation satellite system (GNSS) receiver, including a global positioning system (GPS) receiver, which tracks and provides location coordinates (e.g., latitude, longitude, altitude) for the device 12. Other information associated with the recording of coordinates may include speed, accuracy, and a time stamp for each recorded location. In some embodiments, the location information may be in descriptive form, and geofencing (e.g., performed locally or external to the wearable device 12) is used to transform the descriptive information into coordinate numbers. In some embodiments, the wearable device 12 may comprise indoor location technology, including beacons, RFID or other coded light or even acoustic technologies, Wi-Fi, etc. In some embodiments, GNSS functionality may be performed at the electronics device 14 and/or the monitoring device 16, in addition to, or in lieu of, such functionality being performed at the wearable device 12. Some embodiments of the wearable device 12 may include a motion or inertial tracking sensor, including an accelerometer and/or a gyroscope, providing movement data of the user (e.g., to detect limb movement and type of limb movement to facilitate the determination of whether the user is engaged in sports activities, stair walking, bicycling, etc.). Such gathered data may be communicated to the user via an interface (e.g., an integrated display) on the wearable device 12 and/or on another device or devices. One or more interfaces of the wearable device 12 may also be configured to receive and/or record consequences, including those entered via manual input, audio input, and/or video/image capture input. For instance, the wearable device 12 may include a microphone, camera, and/or a touch-type display screen. The interface may also be configured to provide a playback of the recording(s) of the consequences, such as via speaker functionality and/or electronic messaging (e.g., text and/or graphics) via the integrated display screen.

Also, or alternatively, such data gathered by the wearable device 12 may be communicated (e.g., continually, periodically, and/or aperiodically, including upon request) via a communications module to one or more other devices, such as the electronics device 14, or via the wireless/cellular network 18 to the computing system 22. Such communication may be achieved wirelessly (e.g., using near field communications (NFC) functionality, Blue-tooth functionality, 802.11-based technology, streaming technology, broadband (e.g., 3G, 4G, 5G), etc.) and/or according to a wired medium (e.g., universal serial bus (USB), etc.). In some embodiments, the communications module of the wearable device 12 may receive input from one or more devices, including the electronics device 14, the monitoring device 16, or a device(s) of the computing system 22 and/or send signals to one or more of the devices 14, 16, and/or 22. In some embodiments, communications among the wearable device 12, the electronics device 14, and/or the monitoring device 16, and/or one or more devices of the computing system 22 may be bi-directional, such as to trigger activation, alerts, and/or to receive data. Further discussion of the wearable device 12 is described below in association with FIG. 2.

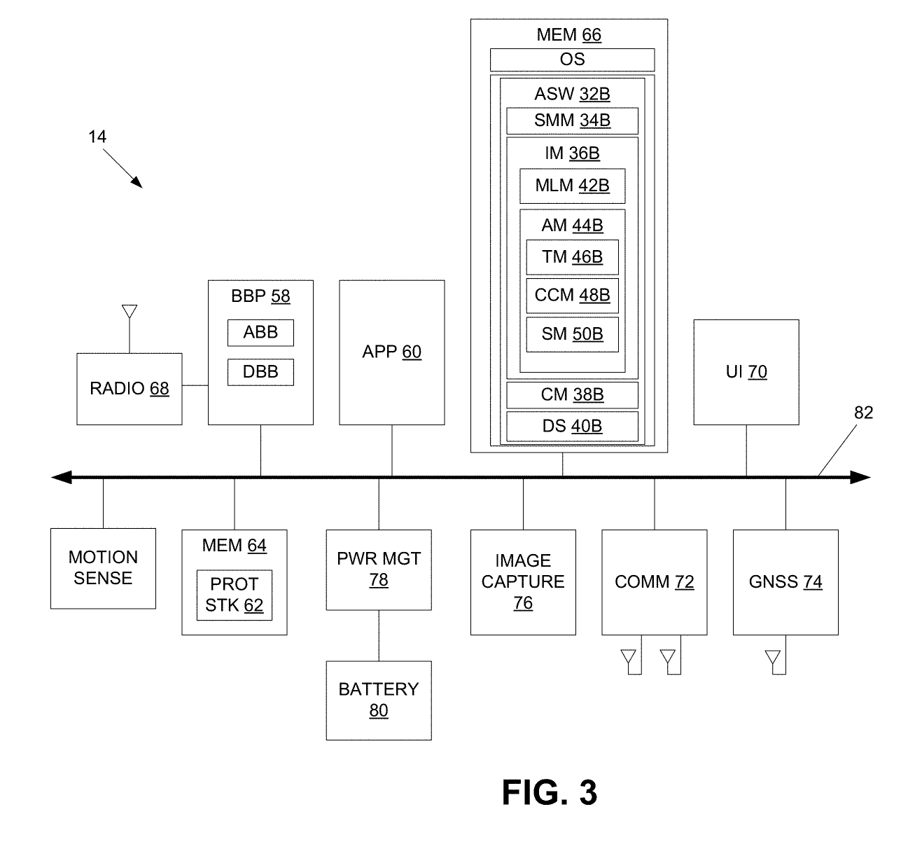

The electronics device 14 may be embodied as a smartphone, mobile phone, cellular phone, pager, stand-alone image capture device (e.g., camera), laptop, workstation, among other handheld and portable computing/communication devices, including communication devices having wireless communication capability, including telephony functionality. In the depicted embodiment of FIG. 1, the electronics device 14 is illustrated as a smartphone for convenience, though it should be appreciated that the electronics device 14 may take the form of other types of devices, including appliances (e.g., implementing the Internet of Things (IoT)), as described above and below. Further discussion of the electronics device 14 is described below in association with FIG. 3, with the terms smartphone and electronics device 14 used interchangeably hereinafter. In one embodiment, the electronics device 14 is configured to perform all or at least a portion of a consequence recording and playback system. The electronics device 14 may be in communications with the wearable device 12, monitoring device 16, and/or one or more devices of the computing system 22. The electronics device 14 may include sensing functionality, including location-sense functionality, motion sense, heart and/or breathing rate monitoring (e.g., using a Philips Vital Signs Camera to remotely measures heart and breathing rate using a standard, infrared (IR) based camera by sensing changes in skin color and body movement (e.g., chest movement)), among others. The electronics device 14 further includes one or more interfaces to receive user input. For instance, the electronics device 14 may include a microphone for recording consequences, or the camera may be used to record consequences in a video or still image format. A touch-type display screen and/or mechanical/electromechanical buttons may be used to receive text entry of consequences and/or provide for playback of the recorded consequences. Wireless communication functionality, including cellular, streaming, broadband, Wi-Fi, Blue-tooth, NFC, etc., may be used for the communication of information among the devices 12, 14, 16, and 22 (device(s) of the remote computing system 22), as explained further below in association with FIG. 3.

The monitoring device 16 comprises one or more sensors to monitor the state, health and/or well-being of an individual. For instance, the monitoring device 16 may be configured as a continuous positive airway pressure (CPAP) device, pill box, external sensor(s) (e.g., weather sensors, load sensors, capacitive sensors, etc.), among other such types of devices, or component thereof. The monitoring device 16 further comprises a communications module (e.g., Bluetooth, acoustic, optical, near field communications, Wi-Fi, streaming, broadband, etc.) to enable communications with one or any combination of the wearable device 12, electronics device 14, and/or one or more device of the computing system 22. For instance, the monitoring device 16 (e.g., integrated with a CPAP device) may detect that the user is not wearing his or her CPAP device, and communicate to a wearable device 12 (or other device) this condition/scenario. The wearable device 12 may sense that the user is about to fall asleep, and triggers playback of a consequence recording warning of the negative effects of not wearing the CPAP device (e.g., triggers playback at the wearable device 12, monitoring device 16, or electronics device 14). These and/or other examples are described further below.

The wireless/cellular network 18 may include the necessary infrastructure to enable wireless and/or cellular communications by the wearable device 12, electronics device 14, and/or the monitoring device 16. There are a number of different digital cellular technologies suitable for use in the wireless/cellular network 18, including: GSM, CPRS, CDMAOne, CDMA2000, Evolution-Data Optimized (EV-DO), EDGE, Universal Mobile Telecommunications System (UMTS), Digital Enhanced Cordless Telecommunications (DECT), Digital AMPS (IS-136/TDMA), and Integrated Digital Enhanced Network (iDEN), among others, as well as streaming, broadband, Wireless-Fidelity (Wi-Fi), 802.11, etc.

The wide area network 20 may comprise one or a plurality of networks that in whole or in part comprise the Internet. The wearable device 12, electronics device 14, and/or the monitoring device 16 may access one or more of the devices of the computing system 22 via the Internet 20, which may be further enabled through access to one or more networks including PSTN (Public Switched Telephone Networks), POTS, Integrated Services Digital Network (ISDN) Ethernet, Fiber, DSUADSL., Wi-Fi, among others.

The computing system 22 comprises one or more devices coupled to the wide area network 20, including one or more computing devices networked together, including an application server(s) and data storage. The computing system 22 may serve as a cloud computing environment (or other server network) for the wearable device 12, electronics device 14, and/or the monitoring device 16, performing processing and/or data storage on behalf of (or in some embodiments, in addition to) the wearable device 12, electronics device 14, and/or the monitoring device 16. One or more devices of the computing system 22 may implement all or at least a portion of certain embodiments of a consequence recording and playback system. When embodied as a cloud service or services, the device(s) of the remote computing system 22 may comprise an internal cloud, an external cloud, a private cloud, or a public cloud (e.g., commercial cloud). For instance, a private cloud may be implemented using a variety of cloud systems including, for example, Eucalyptus Systems, VMWare vSphere®, or Microsoft® HyperV. A public cloud may include, for example, Amazon EC2®, Amazon Web Services®, Terremark®, Savvis®, or GoGrid®. Cloud-computing resources provided by these clouds may include, for example, storage resources (e.g., Storage Area Network (SAN), Network File System (NFS), and Amazon S3®), network resources (e.g., firewall, load-balancer, and proxy server), internal private resources, external private resources, secure public resources, infrastructure-as-a-services (IaaSs), platform-as-a-services (PaaSs), or software-as-a-services (SaaSs). The cloud architecture of the devices of the remote computing system 22 may be embodied according to one of a plurality of different configurations. For instance, if configured according to MICROSOFT AZURE™, roles are provided, which are discrete scalable components built with managed code. Worker roles are for generalized development, and may perform background processing for a web role. Web roles provide a web server and listen for and respond to web requests via an HTTP (hypertext transfer protocol) or HTTPS (HTTP secure) endpoint. VM roles are instantiated according to tenant defined configurations (e.g., resources, guest operating system). Operating system and VM updates are managed by the cloud. A web role and a worker role run in a VM role, which is a virtual machine under the control of the tenant. Storage and SQL services are available to be used by the roles. As with other clouds, the hardware and software environment or platform, including scaling, load balancing, etc., are handled by the cloud.

In some embodiments, the devices of the remote computing system 22 may be configured into multiple, logically-grouped servers (run on server devices), referred to as a server farm. The devices of the remote computing system 22 may be geographically dispersed, administered as a single entity, or distributed among a plurality of server farms, executing one or more applications on behalf of, or processing data from, one or more of the wearable device 12, the electronics device 14, or the monitoring device 16. The devices of the remote computing system 22 within each farm may be heterogeneous. One or more of the devices may operate according to one type of operating system platform (e.g., WINDOWS NT, manufactured by Microsoft Corp. of Redmond, Wash.), while one or more of the other devices may operate according to another type of operating system platform (e.g., Unix or Linux). The group of devices of the remote computing system 22 may be logically grouped as a farm that may be interconnected using a wide-area network (WAN) connection or medium-area network (MAN) connection. The devices of the remote computing system 22 may each be referred to as, and operate according to, a file server device, application server device, web server device, proxy server device, or gateway server device.

In one embodiment, the computing system 22 may comprise a web server that provides a web site that can be used by users to review and/or update their information (e.g., monitored activity, (sub)goals, relevant circumstances, inputted and/or recorded information). The computing system 22 receives data collected via one or more of the wearable device 12, electronics device 14, and/or monitoring device 16 and/or other devices or applications, stores the received data in a data structure (e.g., user profile database) along with one or more tags, processes the information (e.g., to determine opportune times to record and playback consequences), and triggers playback at one or more of the devices 12 and/or 14 in an effort to provoke behavioral change that advances progression towards (or stymies a downward trend away from) a predetermined goal or goals of the user. The computing system 22 is programmed to handle the operations of one or more health or wellness programs implemented on the wearable device 12 and/or electronics device 14 via the networks 18 and/or 20. For example, the computing system 22 processes user registration requests, user device activation requests, user information updating requests, data uploading requests, data synchronization requests, etc. In one embodiment, the data received at the computing system 22 may be stored in a user profile data structure comprising a plurality of measurements pertaining to activity/inactivity, for example, body movements, heart rate, respiration rate, blood pressure, body temperature, light and visual information, etc. In some embodiments, the data structure may include consequence recordings (or an address to those recordings). In some embodiments, the data structure may include a circumstance(s)/context (for the measured data and recordings). Based on the data observed for each user and inputted data regarding prescribed parameters and/or goals, the computing system 22 triggers the recording of consequences and/or triggers playback of the recordings. Triggering may include delivery of the recording (e.g., video/image, audio, and/or electronic messages) for playback at one or more other devices, or in some embodiments, instructions to cause playback of the recordings stored locally (e.g., at the device(s) 12, 14). In some embodiments, the computing system 22 is configured to be a backend server for a health-related program or a health-related application implemented on the devices 12, 14, and/or 16. The functions of the computing system 22 described above are for illustrative purpose only. The present disclosure is not intended to be limiting. The computing system 22 may be a general computing server device or a dedicated computing server device. The computing system 22 may be configured to provide backend support for a program developed by a specific manufacturer. However, the computing system 22 may also be configured to be interoperable across other server devices and generate information in a format that is compatible with other programs. In some embodiments, one or more of the functionality of the computing system 22 may be performed at the respective devices 12, 14, and/or 16.

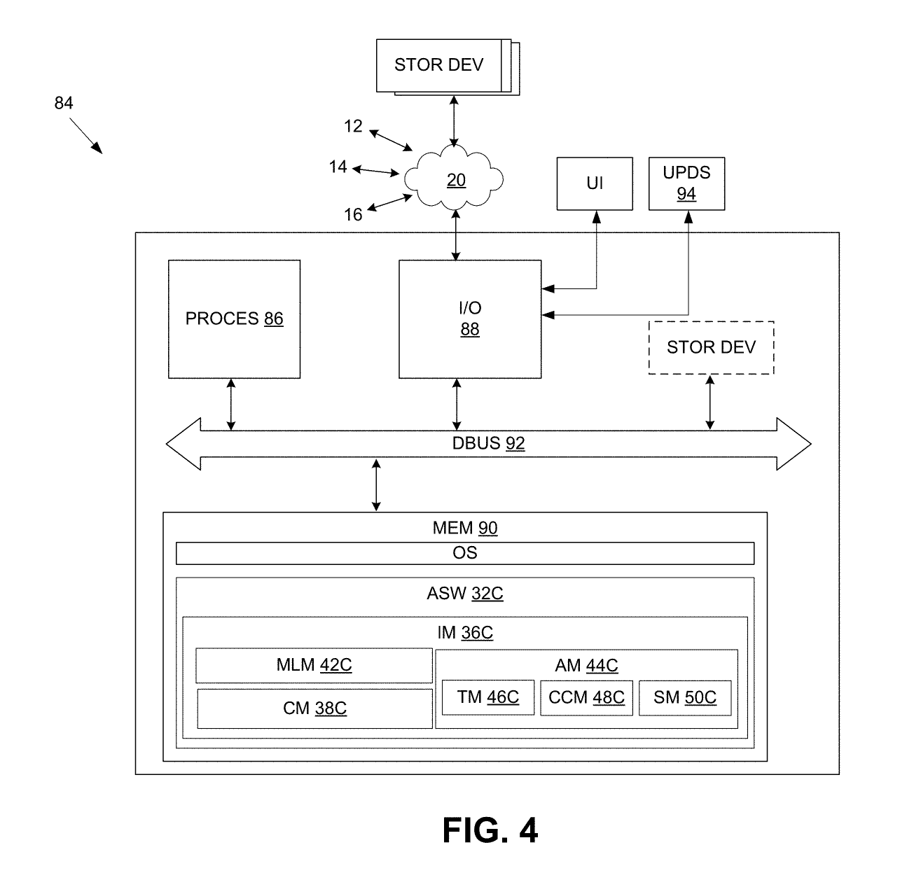

Note that cooperation between devices 12, 14, and/or 16 and the one or more devices of the computing system 22 may be facilitated (or enabled) through the use of one or more application programming interfaces (APIs) that may define one or more parameters that are passed between a calling application and other software code such as an operating system, library routine, function that provides a service, that provides data, or that performs an operation or a computation. The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer employs to access functions supporting the API. In some implementations, an API call may report to an application the capabilities of a device running the application, including input capability, output capability, processing capability, power capability, and communications capability. Further discussion of the computing system 22 is described below in association with FIG. 4.

An embodiment of a consequence recording and playback system may comprise the wearable device 12, the electronics device 14, the monitoring device 16, and/or the computing system 22. In other words, one or more of the aforementioned devices 12, 14, 16 and devices of the remote computing system 22 may implement the functionality of the consequence recording and playback system. For instance, the wearable device 12 may comprise all of the functionality of a consequence recording and playback system, enabling the user to avoid the need for prolonged Internet connectivity and/or carrying a smartphone 14 around. In some embodiments, the functionality of the consequence recording and playback system may be implemented using a combination of the wearable device 12, the electronics device 14, the monitoring device 16, and/or the computing system 22 (with or without the electronics device 14). For instance, the wearable device 12 and/or the electronics device 14 may record and playback the recordings and provide sensing functionality (and/or receive sensing data from the monitoring device 16), yet rely on remote processing of the remote computing system 22 for determining when to capture recordings and/or when to trigger playback.

Attention is now directed to FIG. 2, which illustrates an example wearable device 12 in which all or a portion of the functionality of a consequence recording and playback system may be implemented. That is, FIG. 2 illustrates an example architecture (e.g., hardware and software) for the example wearable device 12. It should be appreciated by one having ordinary skill in the art in the context of the present disclosure that the architecture of the wearable device 12 depicted in FIG. 2 is but one example, and that in some embodiments, additional, fewer, and/or different components may be used to achieve similar and/or additional functionality. In one embodiment, the wearable device 12 comprises a plurality of sensors 24 (e.g., 24A-24N), one or more signal conditioning circuits 26 (e.g., SIG COND CKT 26A-SIG COND CKT 26N) coupled respectively to the sensors 24, and a processing circuit 28 (PROCES CKT) that receives the conditioned signals from the signal conditioning circuits 26. The processing circuit 28 comprises one or more processors. In one embodiment, the processing circuit 28 comprises an analog-to-digital converter (ADC), a digital-to-analog converter (DAC), a microcontroller unit (MCU), a digital signal processor (DSP), and memory (MEM) 30. In some embodiments, the processing circuit 28 may comprise fewer or additional components than those depicted in FIG. 2. For instance, in one embodiment, the processing circuit 28 may consist of the microcontroller. In some embodiments, the processing circuit 28 may include the signal conditioning circuits 26. The memory 30 comprises an operating system (OS) and application software (ASW) 32A. In one embodiment, the application software 32A comprises a plurality of software modules (e.g., executable code/instructions) including sensor measurement module (SMM) 34A, an interface module (IM) 36A, and a communications module (CM) 38A. In some embodiments, the application software 32A may comprise fewer modules, or in some embodiments, additional modules. The memory 30 also comprises, in one embodiment, a data structure (DS) 40A of consequence recordings with associated tags. In some embodiments, the data structure 40A may be accessed from, or reside at, other devices. The tags include a relation to the behavioral activity (or inactivity), whether the consequence has a positive or negative connotation (e.g., by doing X, you benefit Y equals positive, or by not doing X, you negatively impact Y being a negative connotation), a context/circumstance(s), a source of the recording, whether the recording is by the user or another, and/or whether the recording is manual or automatic. In some embodiments, the data structure 40A may have additional information or fewer information.

The sensor measurement module 34A comprises executable code (instructions) to process the signals (and associated data) measured by the sensors 24 and record and/or derive physiological parameters, such as heart rate, blood pressure, respiration, perspiration, etc., and movement/activity and/or contextual data (e.g., location data, weather, etc.).

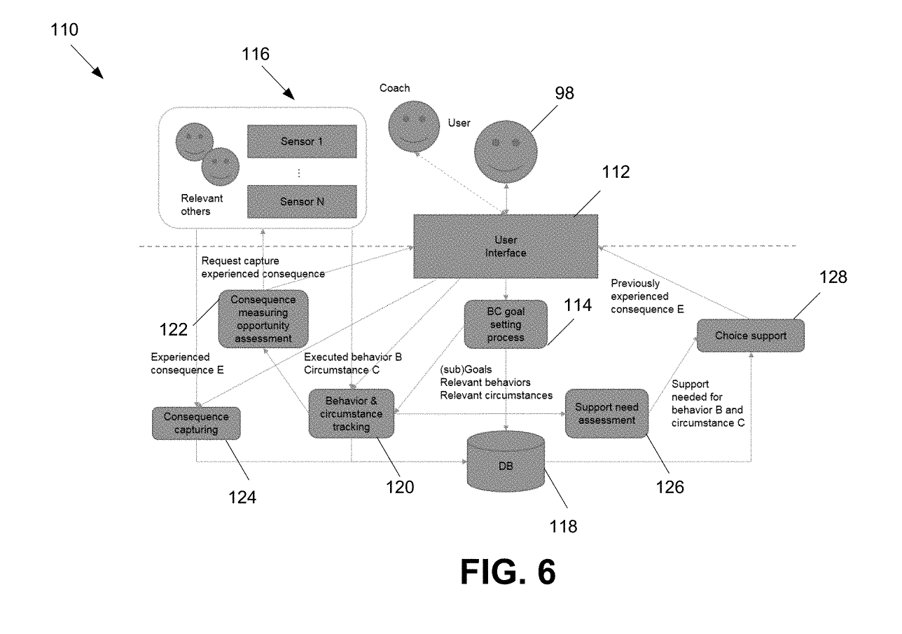

The interface module 36A comprises executable code (instructions) to enable a user to define goals, define the type of behavioral activity/inactivity that should be tracked (e.g., sedentary time and number of steps taken), and define which circumstances (context) to take into account (e.g., weather) while tracking activity and/or inactivity. The interface module 36A may work in conjunction with one or more (physical) user interfaces, as described below. In one embodiment (manual user tracking), the interface module 36A comprises a manual logging module 42A. The manual logging module 42A receives the user input (data) about the behavior he or she has engaged in, the circumstances (context) of the executed behavior (optionally), the experienced consequences of the behavior, and the direction of the message/connotation (positive/negative) of the consequence in the user interface. In some embodiments, if the user provides no, or very little, manual input on behavior and/or experienced consequences, the manual logging module 42A may provide, via a user interface, a prompt for the user to provide such information at fixed points in time (or in some embodiments, at variable points in time). The consequences are recorded and stored in the data structure 40A along with one or more tags as described above. The manual logging module 42A is further configured to receive user requests for support (which prompt a search for, and access to, a relevant consequence), and to provide a trigger for playback of the recorded consequence. For instance, the manual logging module 42A performs a comparison of the predetermined criteria entered by the user (e.g., goal, sub-goal(s), behavior tracked, context) with the data stored in the data structure 40A, and selects and uses the stored recorded consequences with the tags that best match the inputted data for playback. Further description of mechanisms for choosing consequences is described below in association with FIG. 6.

In one embodiment (automatic tracking), the interface module 36A comprises an automatic module 44A. The automatic module 44A enables the consequence recording and playback system to automatically log the behavioral actions and, optionally, context/circumstance(s), with functionality for deducing whether it is a relevant moment to capture a consequence (and to automatically trigger the recording of the consequence) and to provide (automatic) behavioral change support. In addition to being configured to receive data corresponding to behavior to track, goals, sub-goals, as described above for the manual logging module 42A, the automatic module 44A is further configured to receive input for the setting of one or more sensors/services (e.g., setting referring to the connecting of the sensors/services to the system for enabling transfer of data) to track the behavior, and to receive input for setting recording sources to, or conditions for, recording consequences (e.g., the criteria for recording). The tracking sensors/services may be the same as the recording sources in some embodiments, or in some embodiments, there may be overlap between the tracking services/sources and the recording sources. The tracking sources may include user input (e.g., the user himself and/or others), sensors of the wearable device 12 (and/or sensors external to the wearable device 12), and/or applications (e.g., on-line applications, including traffic, weather, etc.). The recording sources may include one or any combination of one or more sensors (e.g., sensors 24 of the wearable device 12 and/or external sensors), user input, or a person familiar with the user (e.g., a coach, mentor, friend, etc.). In some embodiments, the recording sources may include applications (e.g., on-line applications, such as from social media applications).

Further, the automatic module 44A receives input to define one or more parameters to trigger support (e.g., when it is determined that the user has been sedentary for over an hour, or when it is midday and less than 40% of the daily step goal has been reached). The automatic module 44A comprises a tracking module (TM) 46A, which tracks the behavioral actions of the user based on the user input/definitions of behavior to track, goals/sub-goals, and sensors/services, and stores the tracked information in the data structure 40A. The automatic module 44A further comprises a consequence capture module (CCM) 48A that compares the tracked data with the data entered by the user, to define triggers for recording and with what recording sources, to enable a determination of an opportunity to capture consequences of certain behaviors. If it is determined that a consequence is to be recorded, the consequence capture module 48A triggers the recording using the recording sources previously selected. Triggers for recording consequences may be via a signal sent to one or more sensors, or via causing a prompt at a user interface of a device requesting input by the user and/or persons familiar with the user. In some embodiments, one or more of the opportunity determinations may be achieved in distributed fashion. For instance, one or more devices may be pre-programmed to begin recording (capturing) based on one or more conditions. In other words, the recording device may determine the recording opportunity for itself based on the predetermined conditions.

The consequence capture module 48A receives and stores the recordings in the data structure 40A, along with one or more tags. That is, the recorded consequences are tagged by the consequence capture module 48A with the direction (positive/negative effect), the executed behavior leading to the consequence, and/or (optionally) the specific circumstances (context) based on input sourced from within the wearable device 12 (e.g., sensors 24) and/or external to the wearable device 12 (e.g., applications, external sensors, etc.). In some embodiments, the consequence capture module 48A may cause the storage of the recorded consequence(s) at a data structure of one or more other and/or additional devices.

The automatic module 44A further comprises a support module 50A. The support module 50A compares the tracked behavior with the input data/definitions from the user to determine whether and what type of support is needed (e.g., to advance progress towards an inputted goal or sub-goal). In some embodiments, the support module 50A may be configured for adaptive learning. The support module 50A receives (e.g., retrieves) a consequence recording from the data structure 40A (or other data structures, such as from other devices) and causes (triggers) playback of the recording of the consequence (or consequences) via a user interface at the wearable device 12 and/or other user interface (e.g., at another device). In one embodiment, the support module 50A receives a single recording of one consequence, wherein triggering comprises triggering the playback of the single recording. In some embodiments, the support module 50A receives a single recording of multiple consequence, wherein triggering comprises triggering the playback of the single recording. In some embodiments, the support module 50A receives plural recordings of one consequence, wherein triggering comprises triggering the playback of the plural recordings. In some embodiments, the support module 50A receives plural recordings of plural consequences, wherein triggering comprises triggering the playback of the plural recordings. For instance, the support module 50A determines which consequence(s) to cause playback, how many, and the type of consequence (e.g., if you stay sedentary you may end up here (negative consequence) versus if you now become active you may end up here (positive consequence)). In some embodiments, the support module 50A may select a recording or recordings using a random approach, as pre-configured (e.g., in the user input/definition stage), or based on an adaptive approach (e.g., based on what is learned to be most effective for this person). As an example, being sedentary for two (2) hours on a particular sunny morning (e.g., deduced from data of the chair sensor and weather online) may trigger a presentation to the user through a user interface of an audio recording that reports the previously experienced consequence of feeling great after having been physically up and about on a sunny day.

The communications module 38A comprises executable code (instructions) to enable a communications circuit 52 of the wearable device 12 to operate according to one or more of a plurality of different communication technologies (e.g., NFC, Bluetooth, Wi-Fi, further including 802.11, GSM, LTE, CDMA, WCDMA, Zigbee, streaming, broadband, etc.). The communications module 38A, in cooperation with one or more other modules of the application software 32A, may instruct and/or control the communications circuit 52 to transmit triggering signals to one or more sensors (e.g., to commence tracking behavior), triggering signals to one or more recording sources (e.g., to commence recording), signals corresponding to tracked behavior and/or context to one or more other devices, and/or control signals and/or recordings to trigger the playback of recordings at one or more other devices. The communications module 38A, in cooperation with one or more other modules of the application software 32A, may instruct and/or control the communications circuit 52 to receive signals corresponding to raw sensor data and/or the derived information from external sensors and/or other information (e.g., from applications), trigger signals (e.g., to trigger tracking, to trigger recordings, to trigger support), and/or recordings (e.g., from other devices). The communications circuit 52 may communicate with one or more of the devices of the environment 10 (FIG. 1) directly or via an intermediary device (e.g., the electronics device 14). The communications module 38A may also include browser software in some embodiments to enable Internet connectivity. The communications module 38A may also be used to access certain services, such as mapping/place location services, which may be used to determine a context for the sensor data. These services may be used in some embodiments of a consequence recording and playback system, and in some instances, may not be used. In some embodiments, the location services may be performed by a client-server application running on another device or devices.

As indicated above, in one embodiment, the processing circuit 28 is coupled to the communications circuit 52. The communications circuit 52 serves to enable wireless communications between the wearable device 12 and other devices of the environment 10 (FIG. 1). The communications circuit 52 is depicted as a Bluetooth circuit, though not limited to this transceiver configuration. For instance, in some embodiments, the communications circuit 52 may be embodied as any one or a combination of an NFC circuit, Wi-Fi circuit, broadband circuit, streaming circuit, transceiver circuitry based on Zigbee, 802.11, GSM, LTE, CDMA, WCDMA, among others such as optical or ultrasonic based technologies. The processing circuit 28 is further coupled to input/output (I/O) devices or peripherals, including an input interface 54 (INPUT) and the output interface 56 (OUT). Note that in some embodiments, functionality for one or more of the aforementioned circuits and/or software may be combined into fewer components/modules, or in some embodiments, further distributed among additional components/modules or devices. For instance, the processing circuit 28 may be packaged as an integrated circuit that includes the microcontroller (microcontroller unit or MCU), the DSP, and memory 30, whereas the ADC and DAC may be packaged as a separate integrated circuit coupled to the processing circuit 28. In some embodiments, one or more of the functionality for the above-listed components may be combined, such as functionality of the DSP performed by the microcontroller. In some embodiments, one or more of the modules may be implemented in hardware.

The sensors 24 are selected to perform detection and measurement of a plurality of behavioral activity parameters, including walking, running, cycling, and/or other activities, including shopping, walking a dog, working in the garden, sports activities, smoking, fluid intake and type of fluid (e.g., coffee, alcohol beverages, etc.), food intake and type, medicine intake, medical device use, heart rate, heart rate variability, heart rate recovery, blood flow rate, activity level, muscle activity (e.g., movement of limbs, repetitive movement, core movement, body orientation/position, power, speed, acceleration, etc.), muscle tension, blood volume, blood pressure, blood oxygen saturation, respiratory rate, perspiration, skin temperature, body weight, and body composition (e.g., body fat percentage). At least one of the sensors 24 may be embodied as movement detecting sensors, including inertial sensors (e.g., gyroscopes, single or multi-axis accelerometers, such as those using piezoelectric, piezoresistive or capacitive technology in a microelectromechanical system (MEMS) infrastructure for sensing movement). In some embodiments, at least one of the sensors 24 may include GNSS sensors, including a GPS receiver to facilitate determinations of distance, speed, acceleration, location, altitude, etc. (e.g., location data, or generally, sensing movement), in addition to or in lieu of the accelerometer/gyroscope and/or indoor tracking (e.g., Wi-Fi, coded-light based technology, etc.). In some embodiments, GNSS sensors may be included in other devices (e.g., the electronics device 14) in addition to, or in lieu of, those residing in the wearable device 12. The sensors 24 may also include flex and/or force sensors (e.g., using variable resistance), electromyographic sensors, electrocardiographic sensors (e.g., EKG, ECG), magnetic sensors, photoplethysmographic (PPG) sensors, bio-impedance sensors, infrared proximity sensors, acoustic/ultrasonic/audio sensors, a strain gauge, galvanic skin/sweat sensors, pH sensors, temperature sensors, pressure sensors, and photocells. The sensors 24 may include other and/or additional types of sensors for the detection of, for instance, barometric pressure, humidity, outdoor temperature, etc. In some embodiments, GNSS functionality may be achieved via the communications circuit 52 or other circuits coupled to the processing circuit 28.

The signal conditioning circuits 26 include amplifiers and filters, among other signal conditioning components, to condition the sensed signals including data corresponding to the sensed physiological parameters and/or location signals before further processing is implemented at the processing circuit 28. Though depicted in FIG. 2 as respectively associated with each sensor 24, in some embodiments, fewer signal conditioning circuits 26 may be used (e.g., shared for more than one sensor 24). In some embodiments, the signal conditioning circuits 26 (or functionality thereof) may be incorporated elsewhere, such as in the circuitry of the respective sensors 24 or in the processing circuit 28 (or in components residing therein). Further, although described above as involving unidirectional signal flow (e.g., from the sensor 24 to the signal conditioning circuit 26), in some embodiments, signal flow may be bi-directional. For instance, in the case of optical measurements, the microcontroller may cause an optical signal to be emitted from a light source (e.g., light emitting diode(s) or LED(s)) in or coupled to the circuitry of the sensor 24, with the sensor 24 (e.g., photocell) receiving the reflected/refracted signals.

The communications circuit 52 is managed and controlled by the processing circuit 28 (e.g., executing the communications module 38A). The communications circuit 52 is used to wirelessly interface with other devices (e.g., the electronics device 14, the monitoring device 16, and/or one or more devices of the computing system 22, FIG. 1). In one embodiment, the communications circuit 52 may be configured as a Bluetooth transceiver, though in some embodiments, other and/or additional technologies may be used, such as Wi-Fi, GSM, LTE, CDMA and its derivatives, Zigbee, NFC, among others. In the embodiment depicted in FIG. 2, the communications circuit 52 comprises a transmitter circuit (TX CKT), a switch (SW), an antenna, a receiver circuit (RX CKT), a mixing circuit (MIX), and a frequency hopping controller (HOP CTL). The transmitter circuit and the receiver circuit comprise components suitable for providing respective transmission and reception of an RF signal, including a modulator/demodulator, filters, and amplifiers. In some embodiments, demodulation/modulation and/or filtering may be performed in part or in whole by the DSP. The switch switches between receiving and transmitting modes. The mixing circuit may be embodied as a frequency synthesizer and frequency mixers, as controlled by the processing circuit 28. The frequency hopping controller controls the hopping frequency of a transmitted signal based on feedback from a modulator of the transmitter circuit. In some embodiments, functionality for the frequency hopping controller may be implemented by the microcontroller or DSP. Control for the communications circuit 52 may be implemented by the microcontroller, the DSP, or a combination of both. In some embodiments, the communications circuit 52 may have its own dedicated controller that is supervised and/or managed by the microcontroller.

In one example operation, a signal (e.g., at 2.4 GHz) may be received at the antenna and directed by the switch to the receiver circuit. The receiver circuit, in cooperation with the mixing circuit, converts the received signal into an intermediate frequency (IF) signal under frequency hopping control attributed by the frequency hopping controller and then to baseband for further processing by the ADC. On the transmitting side, the baseband signal (e.g., from the DAC of the processing circuit 28) is converted to an IF signal and then RF by the transmitter circuit operating in cooperation with the mixing circuit, with the RF signal passed through the switch and emitted from the antenna under frequency hopping control provided by the frequency hopping controller. The modulator and demodulator of the transmitter and receiver circuits may perform frequency shift keying (FSK) type modulation/demodulation, though not limited to this type of modulation/demodulation, which enables the conversion between IF and baseband. In some embodiments, demodulation/modulation and/or filtering may be performed in part or in whole by the DSP. The memory 30 stores the communications module 38A, which when executed by the microcontroller, controls the Bluetooth (and/or other protocols) transmission/reception.

Though the communications circuit 52 is depicted as an IF-type transceiver, in some embodiments, a direct conversion architecture may be implemented. As noted above, the communications circuit 52 may be embodied according to other and/or additional transceiver technologies.

The processing circuit 28 is depicted in FIG. 2 as including the ADC and DAC. For sensing functionality, the ADC converts the conditioned signal from the signal conditioning circuit 26 and digitizes the signal for further processing by the microcontroller and/or DSP. The ADC may also be used to convert analogs inputs that are received via the input interface 54 to a digital format for further processing by the microcontroller. The ADC may also be used in baseband processing of signals received via the communications circuit 52. The DAC converts digital information to analog information. Its role for sensing functionality may be to control the emission of signals, such as optical signals or acoustic signals, from the sensors 24. The DAC may further be used to cause the output of analog signals from the output interface 56. Also, the DAC may be used to convert the digital information and/or instructions from the microcontroller and/or DSP to analog signals that are fed to the transmitter circuit. In some embodiments, additional conversion circuits may be used.

The microcontroller and the DSP provide processing functionality for the wearable device 12. In some embodiments, functionality of both processors may be combined into a single processor, or further distributed among additional processors. The DSP provides for specialized digital signal processing, and enables an offloading of processing load from the microcontroller. The DSP may be embodied in specialized integrated circuit(s) or as field programmable gate arrays (FPGAs). In one embodiment, the DSP comprises a pipelined architecture, which comprises a central processing unit (CPU), plural circular buffers and separate program and data memories according to, say, a Harvard architecture. The DSP further comprises dual busses, enabling concurrent instruction and data fetches. The DSP may also comprise an instruction cache and I/O controller, such as those found in Analog Devices SHARC® DSPs, though other manufacturers of DSPs may be used (e.g., Freescale multi-core MSC81xx family, Texas Instruments C6000 series, etc.). The DSP is generally utilized for math manipulations using registers and math components that may include a multiplier, arithmetic logic unit (ALU, which performs addition, subtraction, absolute value, logical operations, conversion between fixed and floating point units, etc.), and a barrel shifter. The ability of the DSP to implement fast multiply-accumulates (MACs) enables efficient execution of Fast Fourier Transforms (FFTs) and Finite Impulse Response (FIR) filtering. Some or all of the DSP functions may be performed by the microcontroller. The DSP generally serves an encoding and decoding function in the wearable device 12. For instance, encoding functionality may involve encoding commands or data corresponding to transfer of information to the electronics device 14, monitoring device 16, or a device of the computing system 22. Also, decoding functionality may involve decoding the information received from the sensors 24 (e.g., after processing by the ADC) and/or other devices.

The microcontroller comprises a hardware device for executing software/firmware, particularly that stored in memory 30. The microcontroller can be any custom made or commercially available processor, a central processing unit (CPU), a semiconductor based microprocessor (in the form of a microchip or chip set), a macroprocessor, or generally any device for executing software instructions. Examples of suitable commercially available microprocessors include Intel's® Itanium® and Atom® microprocessors, to name a few non-limiting examples. The microcontroller provides for management and control of the wearable device 12.

The memory 30 can include any one or a combination of volatile memory elements (e.g., random access memory (RAM, such as DRAM, SRAM, SDRAM, etc.)) and nonvolatile memory elements (e.g., ROM, Flash, solid state, EPROM, EEPROM, etc.). Moreover, the memory 30 may incorporate electronic, magnetic, and/or other types of storage media.

The software in memory 30 may include one or more separate programs, each of which comprises an ordered listing of executable instructions for implementing logical functions. In the example of FIG. 2, the software in the memory 30 includes a suitable operating system and the application software 32A, which includes a plurality of software modules 34A-50A for implementing certain embodiments of a consequence recording and playback system and algorithms for determining physiological and/or behavioral measures and/or other information based on the output from the sensors 24 and/or other information. The raw data from the sensors 24 may be used by algorithms of the application software 32A to determine various behavioral activity measures (e.g., heart rate, biomechanics, such as swinging of the arms), and may also be used to derive other parameters, such as energy expenditure, heart rate recovery, aerobic capacity (e.g., VO2 max, etc.), among other derived measures of physical performance. In some embodiments, these derived parameters may be computed externally (e.g., at the electronics devices 14, one or more devices of the computing system 22, etc.) in lieu of, or in addition to, the computations performed local to the wearable device 12.

The operating system essentially controls the execution of computer programs, such as the application software 32A and associated modules 34A-50A, and provides scheduling, input-output control, file and data management, memory management, and communication control and related services. The memory 30 may also include user data, including weight, height, age, gender, goals, body mass index (BMI) that are used by the microcontroller executing the executable code of the algorithms to accurately interpret the tracked data. As set forth above, the memory 30 may also include a data structure 40A for receiving and storing recorded consequences and/or tracked behavioral activity. The memory 30 may also include historical data relating past recorded data to prior contexts. In some embodiments, one or more of the data may be stored elsewhere (e.g., at the electronics device 14 and/or a device of the remote computing system 22).

Although the application software 32A (and component parts 34A-50A) are described above as implemented in the wearable device 12, some embodiments may distribute the corresponding functionality among the wearable device 12 and other devices (e.g., the electronics device 14, the monitoring device 16, and/or one or more devices of the computing system 22), or in some embodiments, functionality of the application software 32A (and component parts 34A-50A) may be implemented in another device (e.g., the electronics device 14, a computing device of the computing system 22, etc.).

The software in memory 30 comprises a source program, executable program (object code), script, or any other entity comprising a set of instructions to be performed. When a source program, then the program may be translated via a compiler, assembler, interpreter, or the like, so as to operate properly in connection with the operating system. Furthermore, the software can be written as (a) an object oriented programming language, which has classes of data and methods, or (b) a procedure programming language, which has routines, subroutines, and/or functions, for example but not limited to, C, C++, Python, Java, among others. The software may be embodied in a computer program product, which may be a non-transitory computer readable medium or other medium.

The input interface(s) 54 comprises one or more interfaces (e.g., including a user interface) for entry of user input, including one or more buttons, a microphone, a camera (e.g., to record consequences in stills and/or video format), and/or a touch-type display (e.g., to record electronic/text messages of a consequence). For instance, in one embodiment, the input interface 54 may comprises a microphone for enabling the audio recording of consequences experienced by the user. In some embodiments, the input interface 54 may serve as a communications port for downloaded information to the wearable device 12 (such as via a wired connection). The output interface(s) 56 comprises one or more interfaces for the playback or transfer of data, including a user interface (e.g., display screen presenting a graphical user interface) or communications interface for the transfer (e.g., wired) of information stored in the memory, or to enable one or more feedback devices, such as lighting devices (e.g., LEDs), audio devices (e.g., tone generator, speaker), and/or tactile feedback devices (e.g., vibratory motor). For instance, the output interface 56 may comprise a display screen and speaker to enable the playback of video images of one or more recorded consequences to the user in some embodiments. In some embodiments, at least some of the functionality of the input and output interfaces 54 and 56, respectively, may be combined.

Note that in one embodiment, functionality of a consequence recording and playback system may be implemented entirely by the wearable device 12, or in some embodiments, by other and/or additional devices of the environment 10 (FIG. 1).

Referring now to FIG. 3, shown is an example electronics device 14 in which all or a portion of the functionality of a consequence recording and playback system may be implemented. In the depicted example, the electronics device 14 is embodied as a smartphone (hereinafter, referred to as smartphone 14 for illustration and convenience), though in some embodiments, other types of devices may be used, such as a workstation, laptop, notebook, tablet, etc. It should be appreciated by one having ordinary skill in the art that the logical block diagram depicted in FIG. 3 and described below is one example, and that other designs may be used in some embodiments. In one embodiment, the application software 32B comprises a plurality of software modules (e.g., executable code/instructions) including a sensor measurement module (SMM) 34B, an interface module (IM) 36B, a communications module (CM) 38B, and a data structure (DS) 40B. The interface module 36B comprises a manual logging module (MLM) 42B and an automatic module (AM) 44, the latter further comprising a tracking module (TM) 46B, a consequence capture module (CCM) 48B, and a support module (SM) 50B. In some embodiments, the application software 32B may comprise fewer modules or additional modules in some embodiments. In some embodiments, one or more of the modules may be implemented in hardware. Functionality of certain embodiments of a consequence recording and playback system may be carried out entirely using the smartphone 14, or in some embodiments, carried out in part with the cooperation of additional devices of the environment 10 (FIG. 1), or in solely in other devices of the environment 10. The smartphone 14 comprises at least two different processors, including a baseband processor (BBP) 58 and an application processor (APP) 60. As is known, the baseband processor 58 primarily handles baseband communication-related tasks and the application processor 60 generally handles inputs and outputs and all applications other than those directly related to baseband processing. The baseband processor 58 comprises a dedicated processor for deploying functionality associated with a protocol stack (PROT STK) 62, such as a GSM (Global System for Mobile communications) protocol stack, among other functions. The application processor 60 comprises a multi-core processor for running applications, including all or a portion of the application software 32B and its corresponding component modules 34B-50B. The baseband processor 58 and application processor 60 have respective associated memory (e.g., MEM) 64, 66, including random access memory (RAM), Flash memory, etc., and peripherals, and a running clock. Note that, though depicted as residing in memory 66, all or a portion of the modules 34B-50B of the application software 32B may be stored in memory 64, distributed among memory 64, 66, or reside in other memory.

More particularly, the baseband processor 58 may deploy functionality of the protocol stack 62 to enable the smartphone 14 to access one or a plurality of wireless network technologies, including WCDMA (Wideband Code Division Multiple Access), CDMA (Code Division Multiple Access), EDGE (Enhanced Data Rates for GSM Evolution), GPRS (General Packet Radio Service), Zigbee (e.g., based on IEEE 802.15.4), Bluetooth, Wi-Fi (Wireless Fidelity, such as based on IEEE 802.11), streaming, broadband, and/or LTE (Long Term Evolution), among variations thereof and/or other telecommunication protocols, standards, and/or specifications. The baseband processor 58 manages radio communications and control functions, including signal modulation, radio frequency shifting, and encoding. The baseband processor 58 comprises, or may be coupled to, a radio (e.g., RF front end) 68 and/or a GSM modem, and analog and digital baseband circuitry (ABB, DBB, respectively in FIG. 3). The radio 68 comprises one or more antennas, a transceiver, and a power amplifier to enable the receiving and transmitting of signals of a plurality of different frequencies, enabling access to the cellular network 18 (FIG. 1), and hence the communication of user data, activity data, associated contexts, and/or recordings (of consequences) to/from the computing system 22 (FIG. 1). The analog baseband circuitry is coupled to the radio 68 and provides an interface between the analog and digital domains of the GSM modem. The analog baseband circuitry comprises circuitry including an analog-to-digital converter (ADC) and digital-to-analog converter (DAC), as well as control and power management/distribution components and an audio codec to process analog and/or digital signals received indirectly via the application processor 60 or directly from the smartphone user interface (UI) 70 (e.g., microphone, speaker, earpiece, ring tone, vibrator circuits, display screen, etc.). The ADC digitizes any analog signals for processing by the digital baseband circuitry. The digital baseband circuitry deploys the functionality of one or more levels of the GSM protocol stack (e.g., Layer 1, Layer 2, etc.), and comprises a microcontroller (e.g., microcontroller unit or MCU, also referred to herein as a processor) and a digital signal processor (DSP, also referred to herein as a processor) that communicate over a shared memory interface (the memory comprising data and control information and parameters that instruct the actions to be taken on the data processed by the application processor 60). The MCU may be embodied as a RISC (reduced instruction set computer) machine that runs a real-time operating system (RTIOS), with cores having a plurality of peripherals (e.g., circuitry packaged as integrated circuits) such as RTC (real-time clock), SPI (serial peripheral interface), I2C (inter-integrated circuit), UARTs (Universal Asynchronous Receiver/Transmitter), devices based on IrDA (Infrared Data Association), SD/MMC (Secure Digital/Multimedia Cards) card controller, keypad scan controller, and USB devices, GPRS crypto module, TDMA (Time Division Multiple Access), smart card reader interface (e.g., for the one or more SIM (Subscriber Identity Module) cards), timers, and among others. For receive-side functionality, the MCU instructs the DSP to receive, for instance, in-phase/quadrature (I/Q) samples from the analog baseband circuitry and perform detection, demodulation, and decoding with reporting back to the MCU. For transmit-side functionality, the MCU presents transmittable data and auxiliary information to the DSP, which encodes the data and provides to the analog baseband circuitry (e.g., converted to analog signals by the DAC).

The application processor 60 operates under control of an operating system (OS) that enables the implementation of a plurality of user applications, including the application software 32B. The application processor 60 may be embodied as a System on a Chip (SOC), and supports a plurality of multimedia related features including web browsing functionality to access one or more computing devices of the computing system 22 (FIG. 1) that are coupled to the Internet, email, multimedia entertainment, games, etc. For instance, the application processor 60 may execute communications module 38B, which may include middleware (e.g., browser with or operable in association with one or more application program interfaces (APIs)) to enable access to a cloud computing framework or other networks to provide remote data access/storage/processing, and through cooperation with an embedded operating system, access to calendars, location services, reminders, etc. For instance, in some embodiments, the consequence recording and playback system may operate using cloud computing, where storage and/or at least some processing are offloaded to one or more remote devices of the computing system 22. The application processor 60 generally comprises a processor core (Advanced RISC Machine or ARM), and further comprises or may be coupled to multimedia modules (for decoding/encoding pictures, video, and/or audio), a graphics processing unit (GPU), communication interfaces (COMM) 72, and device interfaces. In one embodiment, the communication interfaces 72 may include wireless interfaces, including a Bluetooth (BT) (and/or Zigbee in some embodiments) module that enable wireless communications with one or more devices of the environment 10 (FIG. 1), including the wearable device 12, the monitoring device 16, and/or other electronics devices, and a Wi-Fi module for interfacing with a local 802.11 network, according to corresponding software in the communications module 38B. The application processor 60 further comprises, or is coupled to, a global navigation satellite systems (GNSS) transceiver or receiver (GNSS) 74 for enabling access to a satellite network to, for instance, provide coordinate location services. In some embodiments, the GNSS receiver 74, in association with GNSS functionality in the application software 32B (e.g., as part of position determining software or integrated in the communications module 38B), collects contextual data (time and location data, including location coordinates and altitude), which may be used for storage with tracked behavioral activity and/or recordings. In some embodiments, the application software 32B may compute speed of movement of the smartphone 14 (and/or other sensor data, including acceleration data) for recording contextual information. For instance, the application software 32B may also collect information about the means of ambulation, where the GPS data (which may include time coordinates) may be used by the application software 32B to determine speed of travel, which may indicate whether the user is moving within a vehicle, on a bicycle, or walking or running. In some embodiments, other and/or additional data may be used to assess the type of activity, including physiological data (e.g., heart rate, respiration rate, galvanic skin response, etc.) and/or behavioral data. For instance, the smartphone 14 comprises a motion sense module having one or more inertial components (e.g., accelerometer, gyroscope, etc.), which in one embodiment may be used to track user behavioral activity (e.g., running, walking, etc.).

The device interfaces coupled to the application processor 60 may include the user interface 70, including a display screen. The display screen, similar to a display screen of the wearable device user interface, may be embodied in one of several available technologies, including LCD or Liquid Crystal Display (or variants thereof, such as Thin Film Transistor (TFT) LCD, In Plane Switching (IPS) LCD)), light-emitting diode (LED)-based technology, such as organic LED (OLED), Active-Matrix OLED (AMOLED), or retina or haptic-based technology. For instance, the interface module 36B may cooperate with the display screen to present web pages, dashboards, data fields to enter goals, sub-goals, sensors/services to use for tracking behavioral activity and optionally circumstances/context, and/or recording sources for recording of consequences, prompts when to record consequences and/or record activity, and playback of one or more consequences. Other user interfaces 70 may include a keypad, microphone (e.g., to record consequences), speaker (e.g., to playback consequences), ear piece connector, I/O interfaces (e.g., USB (Universal Serial Bus)), SD/MMC card, among other peripherals. Also coupled to the application processor 60 is an image capture device (IMAGE CAPTURE) 76. The image capture device 76 comprises an optical sensor (e.g., a charged coupled device (CCD) or a complementary metal-oxide semiconductor (CMOS) optical sensor). The image capture device 76 may be used to detect various physiological parameters of a user, including blood pressure or breathing rate based on remote photoplethysmography (PPG). The image capture device 76 may also be used to record consequences (e.g., by the user or others). Also included is a power management device 78 that controls and manages operations of a battery 80. The components described above and/or depicted in FIG. 3 share data over one or more busses, and in the depicted example, via data bus 82. It should be appreciated by one having ordinary skill in the art, in the context of the present disclosure, that variations to the above may be deployed in some embodiments to achieve similar functionality.

In the depicted embodiment, the application processor 60 runs the application software 32B, which in one embodiment, includes a plurality of software modules (e.g., executable code/instructions) including a sensor measurement module (SMM) 34B, an interface module (IM) 36B, a communications module (CM) 38B, and a data structure (DS) 40B. The description for the application software 32A has similar applicability to the application software 32B. The interface module 36B comprises a manual logging module (MLM) 42B and an automatic module (AM) 44, the latter comprising a tracking module (TM) 46B, a consequence capture module (CCM) 48B, and a support module (SM) 50B. The sensor measurement module 34B comprises executable code (instructions) to process the signals (and associated data) measured by components of the smartphone 14 used to track behavioral data and/or contexts, including such components as the GNSS receiver 74, the image capture device 76, and/or the motion sense module. For instance, the image capture device 76 may be used to sense physiological parameters, including heart rate and/or respiration, and the motion sense module and/or the GNSS receiver 74 may be used to sense movement/activity and/or contextual data (e.g., location data, weather, etc.). In some embodiments, the smartphone 14 receives, via communications interface 72, sensor data (e.g., to track user behavioral activity) from other devices, including the wearable device 12 and/or the monitoring device 16. The interface module 36B comprises executable code (instructions) to enable a user to define goals/sub-goals, define the type of behavioral activity/inactivity that should be tracked (e.g., sedentary time and number of steps taken), and define which circumstances (context) to take into account (e.g., weather). The interface module 36B may work in conjunction with the user interface 70. In one embodiment (manual user tracking), the interface module 36B comprises a manual logging module 42B. The manual logging module 42B receives the user input (data) about the behavior he or she has engaged in, the circumstances (context) of the executed behavior (optionally), the experienced consequences of the behavior, and the direction of the message/connotation (positive/negative) of the consequence in the user interface. In some embodiments, if the user provides no, or very little, manual input on behavior and/or experienced consequences, the manual logging module 42B may provide, via a user interface, a prompt for the user to provide such information at fixed points in time. The consequences are recorded and stored in the data structure 40B along with one or more tags as described above. The manual logging module 42B is further configured to receive user requests for support (which prompt a search for, and access to, a relevant consequence), and to provide a trigger for playback of the recorded consequence. For instance, the manual logging module 42B performs a comparison of the predetermined criteria entered by the user (e.g., goal, sub-goal(s), behavior tracked, context) with the data stored in the data structure 40B, and selects and uses the stored recorded consequences with the tags that best match the inputted data for playback.

In one embodiment (automatic tracking), the interface module 36B comprises an automatic module 44B. The automatic module 44B enables the consequence recording and playback system to automatically log the behavioral actions and, optionally, context, with functionality for deducing whether it is a relevant moment to capture a consequence (and to automatically trigger the recording of the consequence) and to provide (automatic) behavioral change support. In addition to being configured to receive data corresponding to behavior to track, goals, sub-goals, as described above for the manual logging module 42B, the automatic module 44B is further configured to receive input for the setting of one or more sensors/services to track the behavior, and to receive input for setting recording sources to, or conditions for, recording consequences. As explained above, sensors/services and recording sources may overlap or be the same devices/services. The tracking sources may include user input (e.g., the user himself and/or others), sensors of the smartphone 14 (and/or sensors external to the smartphone 14), and/or applications (e.g., on-line applications, including traffic, weather, etc.). The recording sources may include one or any combination of one or more sensors of the smartphone 14 and/or external sensors), user input, or a person familiar with the user (e.g., a coach, mentor, friend, etc.). In some embodiments, the recording sources may include applications (e.g., on-line applications, such as from social media applications). Further, the automatic module 44B receives input to define one or more parameters to trigger support. The automatic module 44B comprises a tracking module (TM) 46B, which tracks the behavioral actions of the user based on the user input/definitions of behavior to track, goals/sub-goals, and input from the sensors/services, and stores the tracked information in the data structure 40B. The automatic module 44B further comprises a consequence capture module (CCM) 48B that compares the tracked data with the data entered by the user, to define triggers for recording and with what recording sources, to enable a determination of an opportunity to capture consequences of certain behaviors. If it is determined that a consequence is to be recorded, the consequence capture module 48B triggers the recording using the recording sources previously selected (e.g., the image capture device 76, microphone of the UI 70, etc.). Triggers for recording consequences may be via a signal sent to one or more sensors, or via causing a prompt at the user interface 70 requesting input by the user and/or persons familiar with the user. In some embodiments, the recording may be initiated based on the control at the recording device, similar to that explained previously in the description of FIG. 2. The consequence capture module 48B receives and stores the recordings in the data structure 40B, along with one or more tags. That is, the recorded consequences are tagged with the direction (positive/negative effect), the executed behavior leading to the consequence, and/or (optionally) the specific circumstances (context), among other information described above for the wearable device data structure. In some embodiments, the consequence capture module 48B may cause (trigger) the storage of the recorded consequence(s) at a data structure of one or more other and/or additional devices. The automatic module 44B further comprises a support module 50B. The support module 50B compares the tracked behavior with the input data/definitions from the user to determine whether and what type of support is needed (e.g., to advance progress towards an inputted goal or sub-goal). In some embodiments, the support module 50B may be configured for adaptive learning. The support module 50B receives (e.g., retrieves) a consequence recording from the data structure 40B (or other data structures) and causes playback of the recording of the consequence (or consequences) via the user interface 70 and/or other user interface (e.g., at another device). The variations of consequences/recordings described above for the wearable device 12 (FIG. 2) are similarly applicable here. As one example, the support module 50B determines which consequence(s) to cause playback, how many, and the type of consequence. The support module 50B may select a recording or recordings using a random approach, as pre-configured (e.g., in the user input/definition stage), or based on an adaptive approach (e.g., based on what is learned to be most effective for this person).

The communications module 38B comprises executable code (instructions) to enable the communications interface 72 and/or the radio 68 to communicate with other devices of the environment, including the wearable device 12, monitoring device 16, and/or one or more devices of the computing system 22. Communications may be achieved according to one or more communications technologies, including broadband, streaming, GSM, LTE, CDMA, WCDMA, Wi-Fi, 802.11, Bluetooth, NFC, etc.). For instance, the communications module 38B, in cooperation with one or more other modules of the application software 32B, may instruct and/or control the communications interface 72 to transmit triggering signals to one or more sensors (e.g., to commence tracking behavior), triggering signals to one or more recording sources (e.g., to commence recording), signals corresponding to tracked behavior and/or context to one or more other devices, and/or control signals and/or recordings to trigger the playback of recordings at one or more other devices. The communications module 38B, in cooperation with one or more other modules of the application software 32B, may instruct and/or control the communications interface 72 to receive signals corresponding to raw sensor data and/or the derived information from external sensors and/or other information (e.g., from applications), trigger signals (e.g., to trigger tracking, to trigger recordings, to trigger support), and/or recordings (e.g., from other devices). The communications module 38B may also include browser software in some embodiments to enable Internet connectivity. The communications module 38B may also be used to access certain services, such as mapping/place location services, which may be used to determine a context for the sensor data. These services may be used in some embodiments of a consequence recording and playback system, and in some instances, may not be used. In some embodiments, the location services may be performed by a client-server application running on another device or devices. In some embodiments, the communications module 38B may include position determining software, which may include GNSS functionality that operates with the GNSS receiver 74 to interpret the data to provide a location and time of the user activity. The position determining software may provide location coordinates (and a corresponding time) of the user based on the GNSS receiver input. In some embodiments, the position determining software cooperates with local or external location servicing services, wherein the position determining software receives descriptive information and converts the information to latitude and longitude coordinates. In some embodiments, the position determining software may be separate from the communications module 38B.

Referring now to FIG. 4, shown is a computing device 84 that may comprise a device of the remote computing system 22 (FIG. 1) and which may comprise all or a portion of the functionality of a consequence recording and playback system. Functionality of the computing device 84 may be implemented within a single computing device as shown here, or in some embodiments, may be implemented among plural devices (i.e., that collectively perform the functionality described below). In one embodiment, the computing device 84 may be embodied as an application server device, a computer, among other computing devices. One having ordinary skill in the art should appreciate in the context of the present disclosure that the example computing device 84 is merely illustrative of one embodiment, and that some embodiments of computing devices may comprise fewer or additional components, and/or some of the functionality associated with the various components depicted in FIG. 4 may be combined, or further distributed among additional modules or computing devices, in some embodiments. The computing device 84 is depicted in this example as a computer system, including one providing functionality of an application server. It should be appreciated that certain well-known components of computer systems are omitted here to avoid obfuscating relevant features of the computing device 84. In one embodiment, the computing device 84 comprises hardware and software components. In some embodiments, the computing device 84 may comprise additional components or fewer components than those depicted in FIG. 4. For instance, memory may be separate. The computing device 84 comprises one or more processors, such as processor 86 (PROCES), input/output (I/O) interface(s) 88 (I/O), and memory 90 (MEM), all coupled to one or more data busses, such as data bus 92 (DBUS). The memory 90 may include any one or a combination of volatile memory elements (e.g., random-access memory RAM, such as DRAM, and SRAM, etc.) and nonvolatile memory elements (e.g., ROM, Flash, solid state, EPROM, EEPROM, hard drive, tape, CDROM, etc.). The memory 90 may store a native operating system (OS), one or more native applications, emulation systems, or emulated applications for any of a variety of operating systems and/or emulated hardware platforms, emulated operating systems, etc. In some embodiments, the computing device 84 may include, or be coupled to, one or more separate storage devices. For instance, in the depicted embodiment, the computing device 84 is coupled via the I/O interfaces 88 to user profile data structures (UPDS) 94, which includes messaging and recorded consequences. In some embodiments, the user profile data structures 94 may be coupled to the computing device 84 directly via the data bus 92 (e.g., stored in a storage device (STOR DEV)), or in some embodiments, may be stored in network connected storage, in memory 90, or in distributed storage/memory. In some embodiments, the user profile data structures 94 may be stored in a single device or distributed among plural devices. The user profile data structures 94 may be stored in persistent memory (e.g., optical, magnetic, and/or semiconductor memory and associated drives). The user profile data structures 94 are configured to store user profile data. In one embodiment, the user profile data may comprise demographics, tracked behavioral activity (e.g., as communicated by one or more of the devices of the environment 10, FIG. 1), context (which may be included in data corresponding to tracked behavior or accessed from other applications, including on-line weather, social media, etc.), user input, and/or recorded consequences (with associated tags),among other information. For instance, the user profile data may include responses to on-going questions presented at the smartphone 14 of FIG. 2 (e.g., presented to the user daily, weekly, bi-weekly, etc.), including responses to questions concerning user goals, sub-goals, activity/inactivity to be tracked, etc. Additional data structures may be used to record similar information for other users. The user profile data structure 94 may be updated periodically, aperiodically, and/or in response to a request or signal from the wearable device 12, the electronics device 14, the monitoring device 16, and/or the operations of the computing device 84.

In the embodiment depicted in FIG. 4, the memory 90 comprises an operating system (OS) and application software (ASW) 32C. In the depicted embodiment, the application processor 86 runs the application software 32C, which in one embodiment, includes a plurality of software modules (e.g., executable code/instructions) including an interface module (IM) 36C and a communications module (CM) 38C. In some embodiments, all or a portion of the user profile data structure 94 may be packaged as part of the application software 32C. The description for the application software 32A has similar applicability to the application software 32C. The interface module 36C comprises a manual logging module (MLM) 42C and an automatic module (AM) 44C, the latter comprising a tracking module (TM) 46C, a consequence capture module (CCM) 48C, and a support module (SM) 50C. The interface module 36C comprises executable code (instructions) to enable (e.g., via a web-interface presented on their device, including a wearable device 12 and/or an electronics device 14, or via a user interface that operates in conjunction with a client-server application) a user to define goals/sub-goals, define the type of behavioral activity/inactivity that should be tracked (e.g., sedentary time and number of steps taken), and define which circumstances (context) to take into account (e.g., weather). In one embodiment (manual user tracking), the interface module 36C comprises a manual logging module 42C. The manual logging module 42C receives the user input (data) about the behavior he or she has engaged in, the circumstances (context) of the executed behavior (optionally), the experienced consequences of the behavior, and the direction of the message/connotation (positive/negative) of the consequence in the user interface. In some embodiments, if the user provides no, or very little, manual input on behavior and/or experienced consequences, the manual logging module 42C may provide, via a user interface, a prompt for the user to provide such information at fixed (or otherwise) points in time. The consequences are recorded and stored in the user profile data structure 94 along with one or more tags as described above. The manual logging module 42C is further configured to receive user requests for support (which prompt a search for, and access to, a relevant consequence), and to provide a trigger for playback of the recorded consequence. For instance, the manual logging module 42C performs a comparison of the predetermined criteria entered by the user (e.g., goal, sub-goal(s), behavior tracked, context) with the data stored in the user profile data structure 94, and selects and uses the stored recorded consequences with the tags that best match the inputted data for playback.

In one embodiment (automatic tracking), the interface module 36C comprises an automatic module 44C. The automatic module 44C enables the consequence recording and playback system to automatically log the behavioral actions and, optionally, context, with functionality for deducing whether it is a relevant moment to capture a consequence (and to automatically trigger the recording of the consequence) and to provide (automatic) behavioral change support. In addition to being configured to receive data (e.g., from one or more devices of the environment 10, FIG. 1 and communicated to the computing device 84) corresponding to behavior to track, goals, sub-goals, as described above for the manual logging module 42C, the automatic module 44C is further configured to receive input for the setting of one or more sensors/services to track the behavior, and to receive input for setting recording sources to, or conditions for, recording consequences. As set forth previously, the sensors/services and recording sources may overlap or be the same. The tracking sources may include user input (e.g., the user himself and/or others), sensors of one or more of the devices of the environment 10 (FIG. 1), and/or applications (e.g., on-line applications, including traffic, weather, etc.). The recording sources may include one or any combination of one or more sensors of one or more devices of the environment 10), user input, or a person familiar with the user (e.g., a coach, mentor, friend, etc.). In some embodiments, the recording sources may include applications (e.g., on-line applications, such as from social media applications). Further, the automatic module 44C receives input to define one or more parameters to trigger support. The automatic module 44C comprises a tracking module (TM) 46C, which tracks the behavioral actions of the user based on the user input/definitions of behavior to track, goals/sub-goals, and sensors/services, and stores the tracked information in the data user profile data structure 94. The automatic module 44C further comprises a consequence capture module (CCM) 48C that compares the tracked data with the data entered by the user, to define triggers for recording and with what recording sources, to enable a determination of an opportunity to capture consequences of certain behaviors. If it is determined that a consequence is to be recorded, the consequence capture module 48C triggers the recording using the recording sources previously selected (e.g., the image capture device 76 of the electronics device 14 (FIG. 3), microphone of the UI 70 (FIG. 3) of the electronics device 14, input interface 54 of the wearable device 12, FIG. 2, and/or recording devices of other devices, including the monitoring device 16, FIG. 1). In some embodiments, recording may commence based on predetermined conditions at other devices (without a trigger) from the computing device 84. Triggers for recording consequences may be via a signal sent to one or more sensors of one or more devices of the environment 10 (FIG. 1), or via causing a prompt at a user interface(s) of one or more devices of the environment 10, requesting input by the user and/or persons familiar with the user. The consequence capture module 48C receives and stores the recordings in the user profile data structure 94, along with one or more tags. That is, the recorded consequences are tagged with the direction (positive/negative effect), the executed behavior leading to the consequence, and/or (optionally) the specific circumstances (context), among other information. In some embodiments, the consequence capture module 48C may cause the storage of the recorded consequence(s) at a data structure of one or more other and/or additional devices. The automatic module 44C further comprises a support module 50C. The support module 50C compares the tracked behavior with the input data/definitions from the user to determine whether and what type of support is needed (e.g., to advance progress towards an inputted goal or sub-goal). In some embodiments, the support module 50C may be configured for adaptive learning. The support module 50C receives (e.g., retrieves) a consequence recording from the user profile data structure 94 (or other data structures) and causes playback of the recording of the consequence (or consequences) via a user interface of one or more of the devices of the environment 10 (FIG. 1). For instance, the support module 50C determines which consequence(s) to cause playback, how many, and the type of consequence. As set forth above, the variety of recordings/consequences described for the wearable device 12 (FIG. 1) have similar applicability here. The support module 50C may select a recording or recordings using a random approach, as pre-configured (e.g., in the user input/definition stage), or based on an adaptive approach (e.g., based on what is learned to be most effective for this person).

The communications module 38C comprises executable code (instructions) to enable the I/O interfaces 88 to communicate with other devices of the environment, including the wearable device 12, the electronics device 14, and/or the monitoring device 16. Communications may be achieved via the Internet 20 (using server/browser software) in conjunction with the wireless/carrier network 18 as described above. For instance, one or more of the devices of the environment 10 (FIG. 1) may execute an application that is used in conjunction with the computing device 84 (e.g., client/server approach). As an example, a user device (e.g., wearable device 12, FIG. 1) may run a health application that is a client/server type of application (operated both on the computing device 84 and the wearable device 12 with synch-ups periodically, or otherwise, implemented), and when one has set a goal of, say, 10,000 steps per day, and is only at 5,000 steps around 4 pm (tracking the behavior), a self-recorded video about emotional consequences of not having 10,000 steps on a day (tracking the effects) can be pushed via the communications module 38C in conjunction with the I/O interfaces 88 through the health app to the user to provide support. The communications module 38C, in cooperation with one or more other modules of the application software 32C, may instruct and/or control the I/O interfaces 88 to transmit triggering signals to one or more devices or corresponding sensors (e.g., to commence tracking behavior), triggering signals to one or more recording sources (e.g., to commence recording), signals corresponding to tracked behavior and/or context to one or more other devices, and/or control signals and/or recordings to trigger the playback of recordings at one or more other devices. The communications module 38C, in cooperation with one or more other modules of the application software 32C, may instruct and/or control the I/O interfaces 88 to receive signals corresponding to sensor data and/or other information (e.g., from applications), trigger signals (e.g., to trigger tracking, to trigger recordings, to trigger support), and/or recordings (e.g., from other devices). The communications module 38C may also be used to access certain services, such as mapping/place location services, which may be used to determine a context for the sensor data. These services may be used in some embodiments of a consequence recording and playback system, and in some instances, may not be used. In some embodiments, the location services may be performed by a client-server application running on another device or devices.

Execution of the application software 32C (including the associated software modules 36C, 38C, and 42C-50C) may be implemented by the processor 86 under the management and/or control of the operating system, though some embodiments may omit the operating system. The processor 86 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the computing device 84.

The I/O interfaces 88 comprise hardware and/or software to provide one or more interfaces to the Internet 20, as well as to other devices such as a user interface (UI) (e.g., keyboard, mouse, microphone, display screen, etc.) and/or the data structure 94. The user interfaces may include a keyboard, mouse, microphone, immersive head set, display screen, etc., which enable input and/or output by an administrator or other user. The I/O interfaces 88 may comprise any number of interfaces for the input and output of signals (e.g., analog or digital data) for conveyance of information (e.g., data) over various networks and according to various protocols and/or standards.

The user interface (UI) is configured to provide an interface between an administrator or content author and the computing device 84. The administrator may input a request via the user interface, for instance, to manage the user profile data structures 94. Updates to the data structures 94 may also be achieved without administrator intervention.

When certain embodiments of the computing device 84 are implemented at least in part with software (including firmware), as depicted in FIG. 4, it should be noted that the software (e.g., including the application software 32C (and associated modules 36C, 38C, and 42C-50C)) can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program (e.g., executable code or instructions) for use by or in connection with a computer-related system or method. The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiments of the computing device 84 are implemented at least in part with hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), relays, contactors, etc.

The monitoring device 16 may comprise an architecture that can range from comprising a sensor, switch, and communications functionality, to a complete machine with an architecture and intelligence similar to the computing device 84 depicted in FIG. 4. For instance, the monitoring device 16 may comprise a load sensing device in a chair (e.g., to detect whether the user remains seated in the chair for a prolonger period of time) or a smart chair and/or other smart appliances (e.g., pill box, e-wallet, connected refrigerator, smart inhaler, smart glucose monitor), an external image capture device (e.g., Webcam), optical sensor or capacitive sensor to detect whether, for instance, a user has placed his or her breathing apparatus for a CPAP machine properly, among other types of devices. The monitoring devices 16 may include switching circuitry to enable remote activation (e.g., from a signal sent by the wearable device 12, electronics device 14, and/or computing device 84) of the recording of consequences, and communication circuitry for the transmittal of information to be received and processed by one of the devices 12, 14, or 84 to enable a determination of when to trigger the activation at the monitoring device 16 (e.g., when a threshold has been reached, such as a detected load on a chair and duration under load) of the recording. As indicated above, the monitoring device 16 may be programmed to recognize conditions for activating recording without receiving signals from another device in some embodiments.

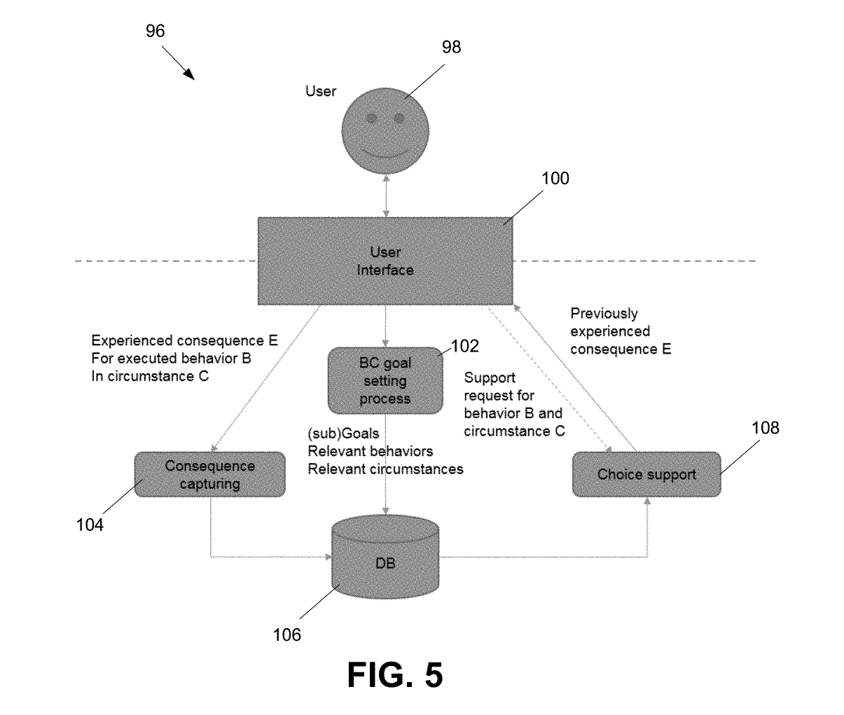

Having described some example architectures for example devices of the environment 10 depicted in FIG. 1, attention is directed now to FIG. 5, which is a flow diagram 96 that conceptually illustrates an embodiment of a consequence recording and playback system using manual control. The operations set forth in FIG. 5 may be implemented by one or more devices of the environment 10 (FIG. 1) executing at least the manual logging module 42 of the application software 32. The primary features depicted in the flow diagram 96 include the setting of a behavior change goal (and defining relevant behaviors and circumstances), tracking the user's behavior and effects (e.g., positive or negative) effects of this behavior, and providing support to the user (e.g., by showing expected effects or consequences of various behavioral options). The flow diagram 96 includes a user 98 interacting with a user interface 100, with further features including a behavior change goal setting process 102, consequence capturing 104, a data structure (e.g., database) 106, and choice support 108. The user 98 starts by setting a behavior change goal 102. For instance, assume the user 98 wants to be more physically active when at work. The user 98 may set more specific sub-goals, including to stand up at least once an hour and/or to walk 10,000 steps per day. These goals/sub-goals may be entered at the user interface 100 (e.g., via entry in an application running at the electronics device 14, FIG. 1, as one example). The process 102 may include defining the goal, defining the type of behavior that should be tracked (e.g., sedentary time and number of steps taken), and defining which circumstances (context) to take into account (e.g., weather). This information is stored into the database 106 and used in the interactions with the user 98 to support manual logging of behavior.

The next step in the process is tracking the user's behavior and the effects of this behavior. In other words, when a behavior change goal and accompanying behavior to be tracked is set, in this case to be more physically active when at work, manual tracking of the behavior and its consequences starts. In the case of manual user tracking as depicted in FIG. 5, the user 98 himself initiates input of data about the behavior, (optionally) the circumstances of the executed behavior, and the experienced consequences of the behavior and its direction (positive/negative) in the user interface 100. When the user provides very little manual input on behavior and experiences consequences, the user interface 100 may prompt the user to provide it on fixed points in time.

After inputting data about the executed behavior (e.g., by answering the questions: 1) “Which behavior do you want to log? A) Being active or B) Being sedentary?” and 2) “How long have you been sedentary?”), the user is asked to record his/her consequences 104 (e.g., emotions, feelings, and/or physical consequences related to this behavior). Input about these consequences can be given in multiple ways, including via text, audio, or a picture/video. The inputted data is then stored in the database 106. Potentially other context circumstances that were identified as relevant to take into account can also be added to the data (e.g., by answering “What is the weather like?”), in order to correlate them with the behavior. This helps to understand under which circumstances the behavior is more/less likely to occur and helps to determine which expected consequence is most relevant to show given a request for support (i.e., a consequence that was experienced under similar circumstances).

The diagram 96 continues by showing the provision of support to the user 98. In the case of manual triggering of support, the user 98 (himself) actively asks for support. For instance, if the user 98 does not feel like being active to reach 10,000 steps and needs a nudge, he enters the user interface 100 to actively ask for help for a specific sub-goal. This action will then trigger the retrieval of an expected consequence of (not) performing the behavior, possibly under the same circumstances, that has been recorded earlier by the user 98. The consequence is played back to the user 98 through the user interface 100 (e.g., a video of the user feeling extremely good after having made a lunch walk).

Referring now to FIG. 6, shown is a flow diagram 110 that conceptually illustrates an embodiment of a consequence recording and playback system using automatic control. The operations set forth in FIG. 6 may be implemented by one or more devices of the environment 10 (FIG. 1) executing at least the automatic module 44 of the application software 32. The primary features depicted in the flow diagram 110 include the setting of a behavior change goal (and defining relevant behaviors and circumstances), tracking the user's behavior and effects through sensors, the user 98, and/or those familiar with the user 98, determining an opportunity to capture effects of certain behaviors, capturing consequence (effects) through people and/or sensors, determining a need for support, and providing the support to the user 98 by showing the expected effects of the various behavior options. Similar to that shown in the flow diagram 96 of FIG. 5, the process in the flow diagram 110 begins by the user 98 setting via the user interface 112 a behavior change goal and possibly sub-goals 114, such as standing up at least once an hour, and walking 10,000 steps per day. However, compared to the manual situation illustrated in FIG. 5, in which the definition of the behavior and circumstances to track is used to facilitate the manual input of data later, in the embodiment depicted in FIG. 6, this definition is followed by setting the sensors/services 116 that will automatically track them (e.g., a monitoring device such as a connected chair, a wearable device such as a smart watch, or one or more applications, such as weather online). The setting of sensors/services 116 involves connecting and configuring the sensors/services to the system to enable transmission of data to a device (e.g., the device managing the triggering of recordings and/or presentation of consequences, including the electronics device 14, computing device 84, or wearable device 12). Potentially also a person could be specified as providing a source of tracking behavior. Similar to behavior tracking, people (e.g., the user 98 and/or one familiar with the user 98) and/or sensors 116 can be specified to record behavioral consequences. Lastly, the user 98 can define parameters as to when to trigger support (e.g., when being sedentary for over an hour, or when midday less than 40% of the daily step goal is reached). The inputted data is stored in a data structure (e.g., database) 118.

Further, based on the input of the previous step, the tracking of the behavior and circumstances relevant for the defined behavior change goal using the specified sensors/services starts 120, where the tracked data is stored in the database 118. In case a human is specified as source of sensors/services (e.g., this could also be the main user himself), this person may be asked (as defined in the previous step) to input data about the behavior of the user (e.g., like in the manual embodiment).

The process continues by determining an opportunity to capture effects of certain behaviors 122. Data gathered from the behavior and circumstance tracking 120 is used to assess when there is a relevant opportunity to capture consequences of behavior 122 (e.g., when the connected chair sensor has detected that a user has been sitting for two (2) hours straight (wrong behavior), or when the smart watch has detected that the user has achieved 10,000 steps (right behavior)).

When such a relevant opportunity to capture consequences is identified/triggered, based on what is defined in the first step, either the user, relevant others, and/or the sensors (collectively, recording sources) are activated to input/record (capture) the consequences of behavior 124. For instance, in the case of tracking consequences of behavior by people, the user or relevant others (e.g., those familiar with the user 98) are asked to input perceptions about the user's characteristics after, or after not, engaging in the desired behavior. For instance a colleague who reports that the user 98 gets really grumpy when being sedentary for the whole day, or the user 98 himself reports back pain after being sedentary for three hours. In the case of tracking consequences of behavior by sensors, the sensor that is defined to record the consequence will automatically start recording when an opportunity is detected. This is particularly relevant for consequences that happen unconsciously (e.g., body posture, but also snoring/apnea when no CPAP device is worn).

The inputted data (from either of the sources) is stored in the database 118. The recorded consequences are tagged with the direction (positive/negative effect), the executed behavior leading to the consequence, and (optionally) the specific circumstances.

Another step in the process depicted in the flow diagram 110 is determining the need for support 126. That is, in the case of automatic triggering of support, based on the information from the sensors that register the behavior and circumstances of the user, an assessment is made whether or not support is needed. Determining parameters for, or for not, giving support is initially done during the goal-setting process 114, but in some embodiments, may be adaptive (e.g., depending on the rate of behavior change success over time).

If a certain condition is reached, support is automatically triggered 128, showing one or more previously experienced consequences of the various behavior options. If in the previous step (126) it has been detected that the user 98 could use a nudge to reach his behavioral goal, a relevant previously experienced consequence is retrieved from the database to show to the user. If one or more consequences are shown, and what type of consequences (e.g., if you stay sedentary you may end up here (negative consequence) versus if you now become active you may end up here (positive consequence)) can either be random, set in the initial goal-setting process 114, or be adaptive based on what is learned to be most effective for this person. For instance, being sedentary for two (2) hours on a particular sunny morning (e.g., deduced from data of the chair sensor and weather online) triggers the presentation to the user through the user interface of the audio recording that reports the previously experienced consequence of feeling great after having been physically up and about on a sunny day.

In one embodiment, recorded content for playback is selected using a tagging scheme as explained above. Each recording may be tagged with the activity or inactivity of the user and the valence of the consequence (positive/negative). In some embodiments, the tags may further be more fine-grained, including the arousal (strength of experience) and/or the people affected (self, other x, other y, etc.). Additional tags may include context parameters (e.g., with whom, in which location, under which condition (weather, emotional state, time of year, time passed since event)), among other information. The tags may be used to select a recording R that in the current context C has the highest expected efficiency Emax in nudging the person into the right behavior Bdesired. This can be determined in one embodiment by determining whether to show effects of Bdesired versus Bundesired (undesired behavior) and selecting a recording from the chosen category (Bdesired versus Bundersired). The determination of whether to show effects of Bdesired versus Bundesired may be via random selection, selection of one of each, selection based on a single assessment of the user's susceptibility of message framing (loss/gain frames), or selection based on a single assessment of the user's susceptibility to self vs others-centered behavioral outcomes. In some embodiments, these susceptibilities (loss vs gain, self vs others) can be learned over time. With regard to selection of a recording from the chosen category (Bdesired versus Bundesired), such selection may be random, based on the valence and arousal associated with the recording (e.g., for Bundersired, the more negative the experience, the more likely it gets selected, and the opposite for Bdesired), based on the similarity of the current context C with the context Crecording (e.g., the higher the overlap, the more likely), or a combination of the ones above. In some embodiments, the effectiveness of certain recordings on influencing the user's behavior can be learned over time and/or the selection process may be corrected by the recency and frequency of the showing of that recording.

It should be appreciated by one having ordinary skill in the art in the context of the present disclosure that a multitude of applications may benefit from implementation by certain embodiments of a consequence recording and playback system. For instance, one embodiment may be applied in digital behavioral change (BC) programs in the consumer and clinical domain to stimulate healthy lifestyles (e.g., physical activity, healthy diet, etc.) and self-management behaviors. These programs often work with a set of goals and include monitoring of behaviors and feeding back progress. In particular, one application may be to increase compliance with CPAP devices (which may be a behavior change goal). When it is detected that a CPAP user is lying in bed but does not wear his device (tracking the behavior, such as by using a bed sensor, smart watch, or a smart-sleep device), a notification is sent to his smartphone and/or the display screen of the CPAP device that shows a video of themselves fighting to breathe at night (tracking consequences and providing support). For instance, using one or more types of tracking devices, it can be deduced that a person is preparing to fall asleep (e.g., depending on the sensor, by analyzing movement, heart rate, EEG, etc.), which in combination with not wearing the device, triggers the support. In some embodiments, how the support is presented (e.g., though the electronics device 14, wearable device 12, or another device, such as a CPAP device) may be predetermined during a user definition stage based on availability. Making such information salient by personalizing the message is more effective than general education about CPAP use.

Many more applications can use certain embodiments of a consequence recording and playback system, including medication adherence (e.g., showing a COPD patient how he feels out of breath if not taken his medicine regularly) or to support stopping certain unhealthy behaviors (e.g., smoking, such as by showing a patient how happy a loved one feels if he does not smoke a cigarette, or how unhappy the loved one feels when he does smoke a cigarette). For instance, with regard to medication adherence, based on use of information from or about an automatic pill dispenser, certain embodiments of a consequence recording and playback system can deduce that a patient did or did not take his medicine. Given that it is known that there are physical state consequences for non-adherence (e.g., effects on HR, blood pressure, cholesterol, etc.), the state can be monitored over a relevant time period and coupled to the initial choice, and presented as an experienced consequence for that behavior (e.g., when you take your pills, your measurements are within acceptable boundaries, whereas if you do not take your medicine, your measurements are outside those boundaries). The action of taking the medicine (or inaction in not taking the medicine) can also trigger a request for the recording of consequences after a relevant time period (e.g., query, “How tired are you feeling today?”).

Another example application concerns hospital or doctor visits. If it is known from previous experiences that a person might not show up for a hospital visit or in doctor check up due to attitudinal (e.g., motivational/anxiety) issues, an embodiment of a consequence recording and playback system may playback to the person, a day in advance of the appointment, recordings of anticipated consequences for showing up (or not showing up). For instance, the recorded consequence(s) may be a personal message from the doctor (e.g., if you do not show you will be billed anyway and/or the next opportunity to ensure good health is xxx time from now), from a loved one (e.g., “Honey, I know it is difficult for you but please go, I really want to get reassured about your health condition”), and/or from yourself (e.g., “I really did not look forward to going to this checkup, but I did and everything turned out to be fine and now I don't have to worry for at least half a year”).

In yet another example, not all applications need involve direct health/medical benefits. For instance, certain embodiments of a consequence recording and playback system may be beneficially used to address harmful and/or addictive behaviors, including those that risk economic harm (e.g., shopaholics, gambling addictions), as well as other unhealthy behavior (e.g., alcoholics). With regard to shopaholics, for instance, a consequence recording and playback system can detect when a person is at risk and/or needs to be supported based on geo-location data (and bank-account information). When the person is tempted to buy something, playback may include the person standing in front of their closet explaining that they really have too much, that so many of the clothes are not worn, and/or that there should be no further purchases. There are many other type of consequence recordings that may be played back. For instance, a recording at the end of the month complaining the person can only afford basic food due to having spent too much money on other stuff, positive recordings, such as when the person has not spent money, he has been able to save and go on a holiday, a recording telling themselves: “if you do not spend this now you are closer to the goal of X in savings”, and/or from another (e.g., child) saying: “please save money for my college.” In situ salient feedback helps to push the person in the right behavioral direction.

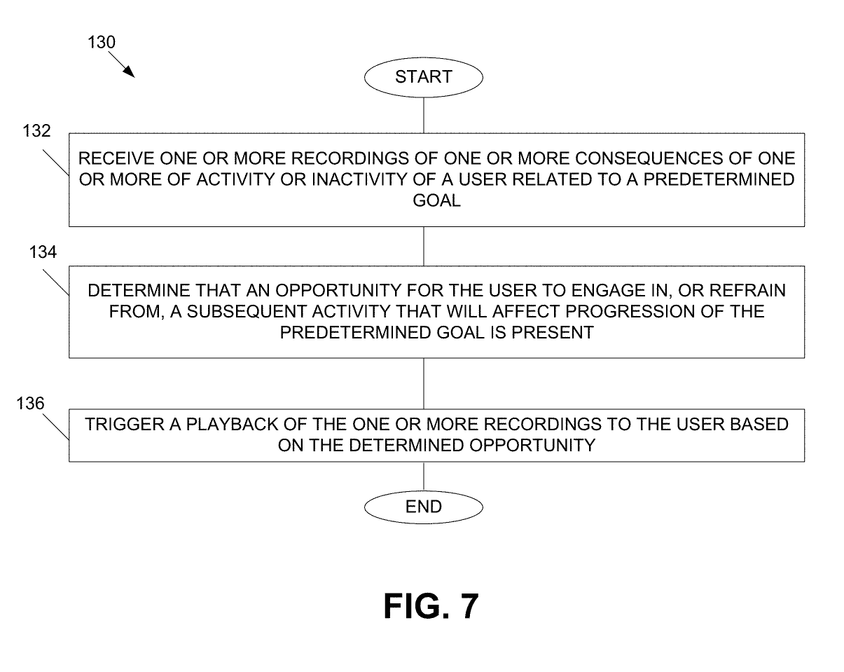

In view of the description above, it should be appreciated that one embodiment of a consequence recording and playback system, depicted in FIG. 7 and referred to as a method 130 and encompassed between start and end designations, comprises receiving one or more recordings of one or more consequences of one or more of activity or inactivity of a user related to a predetermined goal (132); determining that an opportunity for the user to engage in, or refrain from, a subsequent activity that will affect progression of the predetermined goal is present (134); and triggering a playback of the one or more recordings to the user based on the determined opportunity (136).

Any process descriptions or blocks in flow diagrams should be understood as representing modules, segments, or portions of code which include one or more executable instructions for implementing specific logical functions or steps in the process, and alternate implementations are included within the scope of the embodiments in which steps/functions may be omitted, added, and/or executed out of order from that shown or discussed, including substantially concurrently or in reverse order, depending on the functionality involved, as would be understood by those reasonably skilled in the art of the present disclosure.

As used herein, the term “module” may be understood to refer to computer executable software, firmware, hardware, and/or various combinations thereof. It is noted there where a module is a software and/or firmware module, the module is configured to affect the hardware elements of an associated system. It is further noted that the modules shown and described herein are intended as examples. The modules may be combined, integrated, separated, or duplicated to support various applications. Also, a function described herein as being performed at a particular module may be performed at one or more other modules and by one or more other devices instead of or in addition to the function performed at the particular module. Further, the modules may be implemented across multiple devices or other components local or remote to one another. Additionally, the modules may be moved from one device and added to another device, or may be included in both devices.

Note that various combinations of the disclosed embodiments may be used, and hence reference to an embodiment or one embodiment is not meant to exclude features from that embodiment from use with features from other embodiments. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical medium or solid-state medium supplied together with or as part of other hardware, but may also be distributed in other forms. Any reference signs in the claims should be not construed as limiting the scope.

At least the following is claimed:

1. An apparatus, comprising:
a memory comprising instructions; and
one or more processors configured to execute the instructions to:
receive one or more recordings of one or more consequences of one or more of activity or inactivity of a user related to a predetermined goal;
determine that an opportunity for the user to engage in, or refrain from, a subsequent activity that will affect progression of the predetermined goal is present; and
trigger a playback of the one or more recordings to the user based on the determined opportunity.

2. The apparatus of claim 1, wherein the one or more processors are further configured to execute the instructions to receive input corresponding to one or any combination of the goal, sub-goals, the activity, or the inactivity of the user to be tracked.

3. The apparatus of claim 2, wherein the input further comprises a context for the one or any combination of the activity or the inactivity to be tracked.

4. The apparatus of claim 2, wherein the input further comprises selection of one or more recording sources and criteria for initiating the one or more recordings.

5. The apparatus of claim 4, wherein the recording sources comprise one or any combination of the user, a person familiar with the user, or one or more sensors.

6. The apparatus of claim 4, wherein the one or more processors are further configured to execute the instructions to determine the opportunity based on a current activity or inactivity of the user and the criteria for initiating the one or more recordings.

7. The apparatus of claim 2, wherein the one or more processors are further configured to execute the instructions to determine the opportunity based on user input.

8. The apparatus of claim 1, wherein the one or more processors are further configured to execute the instructions to determine an opportunity to trigger the one or more recordings.

9. The apparatus of claim 8, wherein the one or more processors are further configured to execute the instructions to determine the opportunity to trigger the one or more recordings based on one or any combination of user input or sensor input.

10. The apparatus of claim 1, wherein each of the one or more recordings is associated with one or more tags, each of the one or more tags comprising one or any combination of the activity or inactivity, context, or whether a positive or negative message is conveyed.

11. The apparatus of claim 1, wherein the playback of the recording comprises one or any combination of the one or more consequences experienced by the user or experienced by a person familiar with the user, the recording comprising one or any combination of a video recording, an audio recording, or an electronic text or graphic message.

12. The apparatus of claim 1, wherein the one or more consequences are presented based on one or any combination of predetermined criteria, random selection, or adaptive learning based on an effectiveness of changing the behavior of the user in the past.

13. The apparatus of claim 1, wherein the one or more processors are further configured to execute the instructions to:
receive by receiving a single recording of one consequence, wherein the trigger comprises triggering the playback of the single recording; or
receive by receiving a single recording of multiple consequence, wherein the trigger comprises triggering the playback of the single recording.

14. The apparatus of claim 1, wherein the one or more processors are further configured to execute the instructions to:
receive by receiving plural recordings of one consequence, wherein the trigger comprises triggering the playback of the plural recordings; or
receive by receiving plural recordings of plural consequences, wherein the trigger comprises triggering the playback of the plural recordings.

15. The apparatus of claim 1, further comprising one or more sensors configured to provide one or any combination of the one or more recordings, recorded activity, or recorded inactivity to the one or more processors.

16. The apparatus of claim 1, further comprising a communications module configured to receive one or any combination of the one or more recordings, recorded activity, or recorded inactivity from another apparatus and communicate the one or any combination of the one or more recordings, the recorded activity, or the recorded inactivity to the one or more processors.

17. The apparatus of claim 1, further comprising a user interface configured to present the playback of the one or more recordings.

18. The apparatus of claim 1, further comprising a communications module configured to send a triggering signal to prompt the playback at another apparatus.

19. A system, comprising:
one or more sensors, the one or more sensors configured to record one or any combination of user activity, user inactivity, or one or more consequences;
a memory comprising instructions; and
one or more processors configured to execute the instructions to:
receive one or more recordings of the one or more consequences of one or more of activity or inactivity of a user related to a predetermined goal;
determine that an opportunity for the user to engage in, or refrain from, a subsequent activity that will affect progression of the predetermined goal is present; and
trigger a playback of the one or more recordings to the user based on the determined opportunity.

20. A method implemented by one or more processors, comprising:
receiving one or more recordings of one or more consequences of one or more of activity or inactivity of a user related to a predetermined goal;
determining that an opportunity for the user to engage in, or refrain from, a subsequent activity that will affect progression of the predetermined goal is present; and
triggering a playback of the one or more recordings to the user based on the determined opportunity.
